(19) United States
(12) Patent Application Publication
(10) Pub. No.: US 2026/0312648 A1
(43) Pub. Date: Oct. 8, 2026

(54) METHOD AND APPARATUS FOR CHANNEL STATE INFORMATION REPORTING IN A WIRELESS COMMUNICATION SYSTEM

(71) Applicant: Samsung Electronics Co., Ltd., Gyeonggi-do (KR)

(72) Inventors: Karthik M, Bangalore (IN); Diwakar SHARMA, Bangalore (IN); Dattaraj Dileep Raut MULGAONKAR, Bangalore (IN); Santanu MONDAL, Bangalore (IN); Naveed ANJUM, Bangalore (IN)

(21) Appl. No.: 19/481,751

(22) PCT Filed: May 17, 2024
(86) PCT No.: PCT/KR2024/006707

§ 371 Date: Nov. 5, 2025

(30) Foreign Application Priority Data
May 19, 2023 (IN) 202341035245
May 6, 2024 (IN) 202341035245

(51) Int. Cl. H04B 7/06; H04L 5/00

(52) U.S. Cl. CPC H04B 7/0626; H04L 5/0023; H04L 5/0048

(57) ABSTRACT

The disclosure relates to a 5G or 6G communication system for supporting a higher data transmission rate. Specifically, the disclosure related to provide method performed by a user equipment (UE) in a wireless network system. The method includes receiving CSI-RS configuration and corresponding CSI-RS from a network apparatus and selecting a set of basis vectors and corresponding basis coefficients, for representing an entity corresponding to each CSI-RS in a SD, a FD and a doppler or DD for each TRP based on the CSI-RS configuration. The entity is a channel or eigen vector of a channel covariance matrix. Further, the method includes determining a transmission parameter feedback corresponding to the TRPs based on the selected set of basis vectors and basis coefficients. Furthermore, the method includes transmitting a CSI report of the feedback comprising the transmission parameter and receiving downlink transmission from the network apparatus based on the transmission parameter feedback.

### TECHNICAL FIELD

This application is based on and derives the benefit of Indian Provisional Application 202341035245 filed on 19 May 2023, and the Indian Complete application Ser. No. 202341035245 filed on 6 May 2024, the contents of which are incorporated herein by reference. The proposed embodiments relate to the field of wireless communication network. More particularly present disclosure relates to a method for Channel State Information (CSI) reporting for coherent joint transmission (CJT) in a wireless communication network system.

### BACKGROUND ART

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The present disclosure relates to wireless communication systems and, more specifically, the present disclosure relates to method and apparatus for CSI reporting for CJ) in a wireless communication system.

### Solution to Problem

The embodiment herein is to provide a method for CSI reporting for CJT in a wireless communication network system.

The embodiments herein is to provide a design to enhance CSI type-2 codebook-based feedback for medium/high velocities for CJT and m TRP.

The embodiments herein is to provide CSI-Type 2 enhancements for CJT with m TRP where Doppler (medium/high velocities) are not involved.

The embodiments herein is to provide CSI-Type2 enhancements for medium/high velocities for single TRP.

### Advantageous Effects of Invention

Aspects of the present disclosure provide efficient communication methods in a wireless communication system.

### BRIEF DESCRIPTION OF DRAWINGS

These and other features, aspects, and advantages of the present embodiments are illustrated in the accompanying drawings, throughout which like reference letters indicate corresponding parts in the various figures. The embodiments herein will be better understood from the following description with reference to the drawings, in which:

FIG. 1 illustrates a moving UE with doppler communicating with four TRPs, according to the embodiments as disclosed herein;

FIG. 2 is a block diagram that illustrates Frequency Domain (FD) component including Doppler domain (DD) sub-components, according to the embodiments as disclosed herein;

FIG. 3 illustrates a matrices and associated dimensions for Doppler Type-2 CSI feedback for one embodiment, according to various embodiments of the present disclosure;

FIG. 4 illustrates the matrices and associated dimensions for Doppler Type-2 CSI feedback for another embodiment, according to the embodiments as disclosed herein;

FIG. 5 illustrates a block diagram of a UE for CSI reporting for CJT in a wireless communication network system, according to the embodiments as disclosed herein;

FIG. 6 illustrates a block diagram of a network apparatus for CSI reporting for CJT in a wireless communication network system, according to the embodiments as disclosed herein;

FIG. 7 is a flow chart that illustrates a scenario for CSI reporting for CJT in a wireless communication network system, by a UE, according to the embodiments as disclosed herein;

FIG. 8 is a flow chart that illustrates a scenario for CSI reporting for CJT in a wireless communication network system, by a network apparatus, according to the embodiments as disclosed herein;

FIG. 9 is a graph that illustrates delay components obtained by taking DFT of a channel across subcarriers, according to the embodiments disclosed herein;

FIG. 10 is a graph that illustrates offset of delay component obtained by taking DFT of a channel that was multiplied by a complex exponential, according to the embodiments disclosed herein;

FIG. 11 is a graph that illustrates increase in number of delay components when a channel is multiplied by a complex exponential where the normalized digital frequency of the complex exponential is less than unity, according to the embodiments disclosed herein;

FIG. 12 is graph that illustrates increase in number of delay components with offset, when a channel is multiplied by a complex exponential where the normalized digital frequency of the complex exponential is greater than unity and not an integer, according to the embodiments disclosed herein;

FIG. 13 is a graph that illustrates offset of delay components, when DFT of a channel is taken, where the channel has a time offset that manifests itself as a complex exponential, according to the embodiments disclosed herein;

FIG. 14 is a graph that illustrates Doppler components, when DFT of a channel across time is taken, according to the embodiments as disclosed herein.

FIG. 15 is a graph that illustrates offset in Doppler components, when DFT of a channel across time is taken according, when the channel has been multiplied by a Doppler/residual frequency whose normalized digital frequency is an integer, according to the embodiments as disclosed herein.

FIG. 16 is a 2D matrix slice across subbands and time instants, obtained from slicing a 3D matrix across spatial, frequency and time dimensions, according to the embodiments disclosed herein;

FIG. 17 is a block diagram that illustrates 2D FFT, of a slice of channel in frequency and time, according to the embodiments disclosed herein;

FIG. 18 is a block diagram that illustrates DFT or projecting to a 3D basis of a channel across spatial, frequency and time, with three options for rotation, according to the embodiments disclosed herein;

FIG. 19 illustrates a block diagram of a terminal (or a user equipment (UE), according to the embodiments disclosed herein; and

FIG. 20 illustrates a block diagram of network apparatus (or a base station), according to embodiments disclosed herein.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the invention. Furthermore, the elements may have been represented in the drawing by conventional symbols, and the drawings may show only those specific details that are pertinent to the understanding the embodiments of the invention so as not to obscure the drawing with details that will be readily apparent to those of ordinary skill in the art having benefit of the description herein.

### BEST MODE FOR CARRYING OUT THE INVENTION

Accordingly, the embodiment herein is to provide a method for channel state information reporting for coherent joint transmission in a wireless network system. The method includes receiving, by a UE, at least one Channel State Information-reference signal (CSI-RS) configuration and at least one corresponding CSI-RS from a network apparatus in the wireless communication network system, wherein the at least one CSI-RS configuration and one at least one corresponding CSI-RS corresponds to a TRP out of multiple transmission reception points (TRPs) of the network apparatus. The method includes selecting, by the UE, a set of basis vectors and corresponding basis coefficients, for representing an entity corresponding to each CSI-RS in a SD, a FD and a doppler or time domain (DD) for each TRP of the multiple TRPs based on the at least one CSI-RS configuration, wherein the entity is a channel or eigen vector of a channel covariance matrix. The method includes determining, by the UE, at least one transmission parameter feedback corresponding to at least one of the multiple TRPs based on the selected set of basis vectors and basis coefficients that represents the entity in the SD, the FD and the DD. The method includes transmitting, by the UE, a CSI report of the feedback to the network apparatus, wherein the CSI report comprises the at least one transmission parameter corresponding to at least one of the multiple TRPs. The method includes receiving, by the UE, downlink transmission from the network apparatus using the at least one TRP based on the transmission parameter feedback.

In an embodiment, the entity is in spatial domain corresponding to antennas for a given subband and time, called as spatial entity, wherein the spatial entity is processed across subbands for a given time, wherein a subband is a set of contiguous one or more subcarriers in frequency domain, wherein the spatial entity for a particular subband and a particular time is called as spatial-frequency entity, and wherein the spatial-frequency entity is processed across time and is called as spatial-frequency-time entity.

In an embodiment, the method further includes receiving, by the UE, a pre-coded data from the network apparatus, wherein the network apparatus pre-codes data using the at least one transmission parameter; and decoding, by the UE (500), the pre-coded data received from the network apparatus (600).

In an embodiment, by the UE, the at least one transmission parameter feedback comprises at least one of the basis coefficients in at least one dimension of the SD, the FD and the DD, and indices to determine the basis vectors in at least one dimension of SD, FD, DD corresponding to a precoding matrix for at least one TRP of the multiple TRPs.

In an embodiment, for the at least one TRP, a set of basis vectors for the spatial entity and a corresponding set of basis coefficients for the spatial entity is selected, called spatial entity basis coefficients and spatial entity basis vectors, wherein the spatial entity basis vectors is same or different across sub bands, wherein the spatial entity basis vectors is the same or different across time.

In an embodiment, the spatial entity basis coefficients for each spatial basis vector is collected across subbands and time, called as time-frequency basis coefficients, wherein for each set of time-frequency basis coefficients for each spatial entity basis vectors is associated with a corresponding set of basis vectors and basis coefficients, called as time-frequency spatial basis vectors and time-frequency spatial basis coefficients.

In an embodiment, the UE reports in the CSI report comprising at least one of the spatial entity basis vectors, the spatial entity basis coefficients for each subband and across time, the time-frequency spatial basis vectors and time-frequency spatial basis coefficients associated with each of the spatial entity basis vectors, indices of various basis vectors.

In an embodiment, the CSI report is sent for all TRPs, and wherein the spatial entity basis vectors, the spatial entity basis coefficients, the time-frequency spatial basis vectors, and the time-frequency spatial basis coefficients are different for different TRPs.

In an embodiment, for the at least one TRP, a set of basis vectors for the spatial entity and a corresponding set of basis coefficients for the spatial entity is selected, called spatial entity basis coefficients and spatial entity basis vectors, wherein the spatial entity basis vectors is same or different across subbands, and wherein the spatial entity basis vectors is same or different across time.

In an embodiment, the spatial entity basis coefficients for all spatial basis vector is collected across subbands, called as spatial-frequency basis coefficients, wherein the set of spatial-frequency basis coefficients is associated with a set of basis vectors and coefficients, called as spatial-frequency compressed basis coefficient and spatial-frequency compressed basis vectors, wherein each spatial-frequency compressed basis coefficient is collected across time, called as spatial-frequency-time basis coefficients, and wherein each set of spatial-frequency-time basis coefficients is associated with a set of spatial-frequency-time compressed basis vectors and the spatial-frequency-time compressed basis coefficients.

In an embodiment, the UE reports in the CSI report comprising at least one of the spatial entity basis vectors, the spatial-frequency compressed basis vectors, the spatial-frequency-time compressed basis vectors and the spatial-frequency-time compressed basis coefficients for each TRP or any of associated indices for the spatial-frequency compressed basis vectors and the spatial-frequency-time compressed basis vectors.

In an embodiment, the spatial entity basis vectors, the spatial-frequency compressed basis vectors, the spatial-frequency-time compressed basis vectors and the spatial-frequency-time compressed basis coefficients are different for different TRPs.

In an embodiment, for at least one TRP, a set of basis vectors for the spatial entity and a corresponding set of basis coefficients for the spatial entity is selected, called spatial entity basis coefficients and spatial entity basis vectors, wherein spatial entity basis vectors is same or different across subbands, wherein spatial entity basis vectors is the same or different across time.

In an embodiment, the spatial entity basis coefficients for each spatial basis vector is collected across subbands and time, called as time-frequency basis coefficients, wherein for each time-frequency basis coefficients for each spatial entity basis vectors is associated with a corresponding set of basis vectors or and basis coefficients, called as time-frequency spatial basis vectors and time-frequency spatial basis coefficients.

In an embodiment, the UE reports in the CSI report comprising at least one of the spatial entity basis vectors, the spatial entity basis coefficients for each subband and across time, the time-frequency spatial basis vectors and time-frequency spatial basis coefficients associated with each of the spatial entity basis vectors, or indices of various basis vectors.

In an embodiment, the CSI report is sent for all TRPs, and wherein the spatial entity basis vectors, the spatial entity basis coefficients are different for different TRPs, the time-frequency spatial basis coefficients is common across TRPs, the time-frequency spatial basis vectors is common across TRPs.

In an embodiment, for the at least one TRP, a set of basis vectors for the spatial entity and a corresponding set of basis coefficients for the spatial entity is selected, called spatial entity basis coefficients and spatial entity basis vectors, wherein the spatial entity basis vectors is same or different across subbands, wherein spatial entity basis vectors is the same or different across time.

In an embodiment, the spatial basis coefficients for all spatial basis vectors is collected across subbands, called as spatial-frequency basis coefficients, wherein the set of spatial-frequency basis coefficients is associated with a set of basis vectors and coefficients, called as spatial-frequency compressed basis coefficient and spatial-frequency compressed basis vectors, and wherein each of the spatial-frequency compressed basis coefficient is collected across time, called as spatial-frequency-time basis coefficients, and wherein each set of spatial-frequency-time basis coefficients is associated with a set of spatial-frequency-time compressed basis vectors and the spatial-frequency-time compressed basis coefficients.

In an embodiment, the UE reports in the CSI report comprising at least one of the spatial entity basis vectors, the spatial-frequency compressed basis vectors, the spatial-frequency-time compressed basis vectors and the spatial-frequency-time compressed basis coefficients for each TRP.

In an embodiment, the spatial frequency compressed basis vectors are different for different TRPs, spatial frequency time compressed basis coefficients is different across TRPs and spatial frequency time basis vectors is common for all TRPs.

In an embodiment, the basis vectors in the FD and/or the DD is a feedback to the network apparatus (600) or TRP via one or more indices of the basis vectors for each TRP, wherein the indices is common across the TRPs, wherein for each TRP, a rotation factor or offset corresponding to the basis vectors in the FD and/or the DD is sent, and wherein using the rotation factors or the offsets for each TRP and common indices across the TRPs of the basis vectors in the FD and/or the DD, the network apparatus (600) computes the actual basis vectors for each TRP in the FD and/or the DD.

In an embodiment, the basis vectors in the SD, the FD, the DD, is one of DFT basis, oversampled DFT basis, Slepian or discrete prolate spheroidal sequence basis or DCT basis or Karhunen-Love basis.

Accordingly, the embodiment herein is to provide a method for channel state information reporting for coherent joint transmission in a wireless network system. The method includes sending, by a network apparatus, at least one Channel State Information-reference signal (CSI-RS) configuration and at least one corresponding CSI-RS to a User Equipment (UE) in the wireless network system, wherein the at least one CSI-RS configuration and the at least one corresponding CSI-RS corresponds to at least one TRP out of multiple transmission reception points (TRPs) of the network apparatus. The method includes receiving, by the network apparatus, a CSI report from the UE, wherein the CSI report comprises transmission parameter feedback corresponding to the at least one TRP of multiple TRP of the network apparatus. The method includes precoding, by the network apparatus, in at least one TRP data based on the transmission parameter feedback. The method includes transmitting, by the network apparatus, the pre-coded data in a downlink transmission using the at least one TRP of the multiple TRPs to the UE based on the transmission parameter feedback received from the UE.

In an embodiment, precoding, data based on the transmission parameter feedback comprises: receiving and using, by the network apparatus, spatial entity basis coefficients and the spatial entity basis vectors from the UE for at least one subband and at least one time instant for the at least one TRP of the multiple TRPs based on the transmission parameter feedback, wherein the spatial entity basis vectors and the spatial entity basis coefficients are represents an entity corresponding to the at least one CSI-RS in at least one of a spatial domain (SD), a frequency domain (FD) and a doppler or time domain (DD) for the at least one TRP based on the at least one CSI-RS configuration; receiving and using, by the network apparatus from UE, at least one of time-frequency spatial basis coefficients, time-frequency spatial basis vectors, spatial frequency compressed basis vectors, spatial frequency time compressed basis vectors, spatial frequency time compressed basis coefficients for at least one TRP; and precoding, by the network apparatus, data based on the spatial entity basis coefficients and the spatial entity basis vectors, time-frequency spatial basis coefficients, time-frequency spatial basis vectors, spatial frequency compressed basis vectors, spatial frequency time compressed basis vectors, spatial frequency time compressed basis coefficients.

In an embodiment, the at least one transmission parameter feedback comprises at least one of the basis coefficients in at least one dimension of the SD, the FD and the DD, and indices to determine basis vectors in at least one dimension of the SD, the FD, the DD corresponding to a precoding matrix for at least one TRP of the multiple TRPs.

In an embodiment, the entity is a channel or eigen vector of a channel covariance matrix, and wherein the entity is in spatial domain corresponding to antennas for a given subband and time, called as spatial entity, wherein the spatial entity is processed across subbands for a given time, wherein a subband is a set of contiguous one or more subcarriers in frequency domain, wherein the spatial entity for a particular subband and a particular time is called as spatial-frequency entity, and wherein the spatial-frequency entity is processed across time and is called as spatial-frequency-time entity.

Accordingly, the embodiment herein is to provide a UE for channel state information reporting for coherent joint transmission in a wireless network system. The UE includes a memory, a processor, a communicator, and a coherent joint transmission controller, coupled to the memory and the processor, wherein the coherent joint transmission controller further configured to: receives at least one Channel State Information-reference signal (CSI-RS) configuration and at least one corresponding CSI-RS from a network apparatus in the wireless network system, wherein the at least one CSI-RS configuration and one at least one corresponding CSI-RS corresponds to a TRP out of multiple transmission reception points (TRPs) of the network apparatus; selects a set of basis vectors and corresponding basis coefficients, for representing an entity corresponding to each CSI-RS in a spatial domain (SD), a frequency domain (FD) and a doppler or time domain (DD) for each TRP of the multiple TRPs based on the at least one CSI-RS configuration, wherein the entity is a channel or eigen vector of a channel covariance matrix; determines at least one transmission parameter feedback corresponding to at least one of the multiple TRPs based on the selected set of basis vectors and basis coefficients that represents the entity in the SD, the FD and the DD; transmits a CSI report of the feedback to the network apparatus, wherein the CSI report comprises the at least one transmission parameter corresponding to at least one of the multiple TRPs; and receives downlink transmission from the network apparatus using the at least one TRP based on the transmission parameter feedback.

Accordingly, the embodiment herein is to provide a network apparatus (600) for channel state information reporting for coherent joint transmission in a wireless communication network system. The network apparatus includes a memory; a processor, a communicator, and a coherent joint transmission controller, coupled to the memory and the processor, wherein the coherent joint transmission: sends at least one Channel State Information-reference signal (CSI-RS) configuration and at least one corresponding CSI-RS to a User Equipment (UE) in the wireless network system, wherein the at least one CSI-RS configuration and the at least one corresponding CSI-RS corresponds to at least one TRP out of multiple transmission reception points (TRPs) of the network apparatus; receives a CSI report from the UE (500), wherein the CSI report comprises transmission parameter feedback corresponding to the at least one TRP of multiple TRP of the network apparatus; precodes in at least one TRP data based on the transmission parameter feedback; and transmits the pre-coded data in a downlink transmission using the at least one TRP of the multiple TRPs to the UE based on the transmission parameter feedback received from the UE.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples are not be construed as limiting the scope of the embodiments herein.

As is traditional in the field, embodiments are described and illustrated in terms of blocks that carry out a described function or functions. These blocks, which referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and optionally be driven by firmware and software. The circuits, for example, be embodied in one or more semiconductor chips, or on substrate supports such as printed circuit boards and the like. The circuits constituting a block be implemented by dedicated hardware, or by a processor (e.g., one or more programmed microprocessors and associated circuitry), or by a combination of dedicated hardware to perform some functions of the block and a processor to perform other functions of the block. Each block of the embodiments be physically separated into two or more interacting and discrete blocks without departing from the scope of the proposed method. Likewise, the blocks of the embodiments be physically combined into more complex blocks without departing from the scope of the proposed method.

The accompanying drawings are used to help easily understand various technical features and it is understood that the embodiments presented herein are not limited by the accompanying drawings. As such, the proposed method is construed to extend to any alterations, equivalents and substitutes in addition to those which are particularly set out in the accompanying drawings. Although the terms first, second, etc. used herein to describe various elements, these elements are not be limited by these terms. These terms are generally used to distinguish one element from another.

Accordingly, the embodiments disclose method for CSI reporting for CJT in a wireless communication network system. The method includes receiving, by a UE, at least one CSI-RS configuration and at least one corresponding CSI-RS from a network apparatus in the wireless network system. The at least one CSI-RS configuration and one at least one corresponding CSI-RS corresponds to a TRP out of multiple TRP of the network apparatus. Further, the method includes selecting, by the UE, a set of basis vectors and corresponding basis coefficients, for representing an entity corresponding to each CSI-RS in a SD, a FD and a DD for each TRP of the multiple TRPs based on the at least one CSI-RS configuration. The entity is a channel or eigen vector of a channel covariance matrix. Further, the method includes determining, by the UE, at least one transmission parameter feedback corresponding to at least one of the multiple TRPs based on the selected set of basis vectors and basis coefficients that represents the entity in the SD, the FD and the DD. Furthermore, the method includes transmitting, by the UE, a CSI report of the feedback to the network apparatus comprising the at least one transmission parameter corresponding to at least one of the multiple TRPs. Further, the method includes receiving, by the UE, downlink transmission from the network apparatus using the at least one TRP based on the transmission parameter feedback.

Accordingly, the embodiments disclose method for CSI reporting for CJT in a wireless communication network system. The method includes sending, by a network apparatus, at least one CSI-RS configuration and at least one corresponding CSI-RS to a UE in the wireless network system. The at least one CSI-RS configuration and the at least one corresponding CSI-RS corresponds to at least one TRP out of multiple TRP of the network apparatus. Further, the method includes receiving, by the network apparatus, a CSI report from the UE, wherein the CSI report comprises transmission parameter feedback corresponding to the at least one TRP of multiple TRP of the network apparatus. Further, the method includes precoding, by the network apparatus, in at least one TRP data based on the transmission parameter feedback. Further, the method includes transmitting, by the network apparatus, the pre-coded data in a downlink transmission using the at least one TRP of the multiple TRPs to the UE based on the transmission parameter feedback received from the UE.

Accordingly, the embodiment herein is to provide a UE for channel state information reporting for coherent joint transmission in a wireless network system. The UE comprises a memory comprising information of a network apparatus in the wireless communication network system, a processor, a communicator, and a coherent joint transmission controller. The coherent joint transmission controller receives at least one Channel CSI-RS configuration and at least one corresponding CSI-RS from a network apparatus in the wireless communication network system. The at least one CSI-RS configuration and one at least one corresponding CSI-RS corresponds to a TRP out of multiple TRPs of the network apparatus. Further, the coherent joint transmission controller selects a set of basis vectors and corresponding basis coefficients, for representing an entity corresponding to each CSI-RS in a SD, a FD and a doppler or DD for each TRP of the multiple TRPs based on the at least one CSI-RS configuration. The entity is a channel or eigen vector of a channel covariance matrix. Further, the coherent joint transmission controller, determines at least one transmission parameter feedback corresponding to at least one of the multiple TRPs based on the selected set of basis vectors and basis coefficients that represents the entity in the SD, the FD and the DD. Further, the coherent joint transmission controller, transmits a CSI report of the feedback to the network apparatus comprising the at least one transmission parameter corresponding to at least one of the multiple TRPs. Further, the coherent joint transmission controller, receives downlink transmission from the network apparatus using the at least one TRP based on the transmission parameter feedback.

Accordingly, the embodiment herein is to provide a network apparatus for CSI reporting for CJT in a wireless network system. The network apparatus comprises a memory comprising information of a network apparatus in the wireless communication network system, a processor, a communicator, and a coherent joint transmission controller. The coherent joint transmission controller sends at least one CSI-RS configuration and at least one corresponding CSI-RS to a UE in the wireless network system. The at least one CSI-RS configuration and the at least one corresponding CSI-RS corresponds to at least one TRP out of multiple TRP of the network apparatus. Further, the coherent joint controller receives a CSI report from the UE. The CSI report comprises transmission parameter feedback corresponding to the at least one TRP of multiple TRP of the network apparatus. Further, the coherent joint controller precodes in at least one TRP data based on the transmission parameter feedback. Further, the coherent joint controller transmits the pre-coded data in a downlink transmission using the at least one TRP of the multiple TRPs to the UE based on the transmission parameter feedback received from the UE.

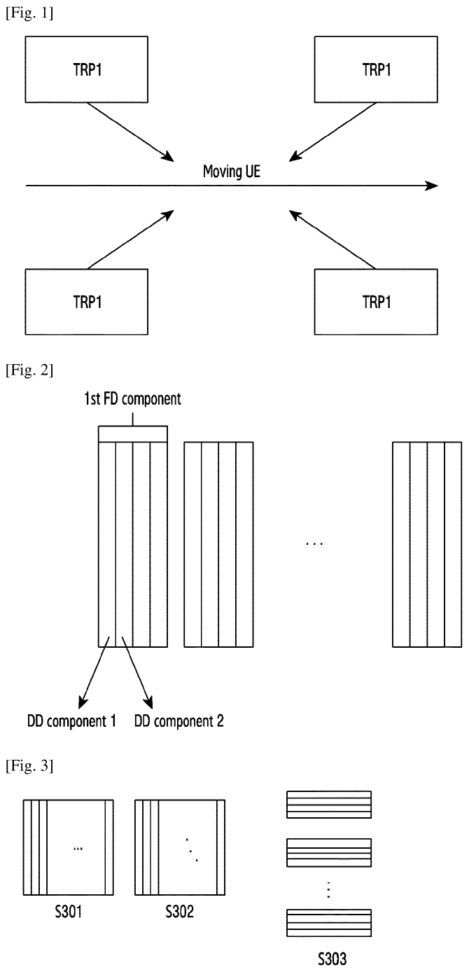

In the present situation, in FIG. 1 for a moving UE with the Doppler communicating with four TRPs and in the context the CSI-Type2 feedback to all the TRPs need to be determined. Therefore, there is a need to enhance the CSI-type-2 codebook-based feedback for medium or high velocities for CJT and mTRP.

The present solution offers an elegant approach, for CSI for channel state information reporting for coherent joint transmission in a wireless network system. The CSI Release 16 introduces enhanced CSI feedback by compressing the CSI report in frequency domain and extending codebook type II to support Multiple-Input Multiple-Output (MIMO) channels with rank larger than two. The CSI type-2 enhancements are pursued in ongoing RAN1 Release-18 in the aspects such as enhancements for medium/high velocities for single TRP and enhancements for CJT with mTRP where Doppler (medium/high velocities) are not involved.

In one aspect, the embodiments herein are achieved by providing a method for CSI reporting for CJT in a wireless communication network system. The method includes receiving, by a UE, at least one CSI-RS configuration and at least one corresponding CSI-RS from a network apparatus in the wireless network system. At least one CSI-RS configuration and one at least one corresponding CSI-RS corresponds to a TRP out of multiple transmission reception points (TRPs) of the network apparatus. Further, the method includes selecting, by the UE, a set of basis vectors and corresponding basis coefficients, for representing an entity corresponding to each CSI-RS in a spatial domain (SD), a frequency domain (FD) and a doppler or time domain (DD) for each TRP of the multiple TRPs based on the at least one CSI-RS configuration. The entity is a channel or eigen vector of a channel covariance matrix. Further, the method includes determining, by the UE, at least one transmission parameter feedback corresponding to at least one of the multiple TRPs based on the selected set of basis vectors and basis coefficients that represents the entity in the SD, the FD and the DD. Further, the method includes transmitting by the UE a CSI report of the feedback to the network apparatus comprising the at least one transmission parameter corresponding to at least one of the multiple TRPs and receiving by the UE downlink transmission from the network apparatus using the at least one TRP based on the transmission parameter feedback.

In an embodiment, the entity is in spatial domain corresponding to antennas for a given subband and time, called as spatial entity. The spatial entity is processed across subbands for a given time, wherein a subband is a set of contiguous one or more subcarriers in frequency domain, wherein the spatial entity for a particular subband and a part time is called as spatial-frequency entity, and wherein the spatial-frequency entity is processed across time and is called as spatial-frequency-time entity.

In an embodiment, the method includes receiving, by the UE, a pre-coded data from the network apparatus, wherein the network apparatus pre-codes data using the at least one transmission parameter. Further, the method includes decoding, by the UE, the pre-coded data received from the network apparatus.

In an embodiment, the at least one transmission parameter feedback comprises at least one of the basis coefficients in at least one dimension of the SD, the FD and the DD, and indices to determine the basis vectors in at least one dimension of SD, FD, DD corresponding to a precoding matrix for at least one TRP of the multiple TRPs.

In an embodiment, the at least one TRP, a set of basis vectors for the spatial entity and a corresponding set of basis coefficients for the spatial entity is selected, called spatial entity basis coefficients and spatial entity basis vectors. The spatial entity basis vectors is same or different across sub bands, the spatial entity basis vectors is the same or different across time.

In an embodiment, for the at least one TRP, a set of basis vectors for the spatial entity and a corresponding set of basis coefficients for the spatial entity is selected, called spatial entity basis coefficients and spatial entity basis vectors, wherein the spatial entity basis vectors is same or different across sub bands, wherein the spatial entity basis vectors is the same or different across time.

In an embodiment, the spatial entity basis coefficients for each spatial basis vector is collected across subbands and time, called as time-frequency basis coefficients, wherein for each set of time-frequency basis coefficients for each spatial entity basis vectors is associated with a corresponding set of basis vectors and basis coefficients, called as time-frequency spatial basis vectors and time-frequency spatial basis coefficients.

In an embodiment, the UE reports in the CSI report comprising at least one of the spatial entity basis vectors, the spatial entity basis coefficients for each subband and across time, the time-frequency spatial basis vectors and time-frequency spatial basis coefficients associated with each of the spatial entity basis vectors, indices of various basis vectors.

In an embodiment the CSI report is sent for all TRPs, and wherein the spatial entity basis vectors, the spatial entity basis coefficients, the time-frequency spatial basis vectors, and the time-frequency spatial basis coefficients are different for different TRPs.

In an embodiment, the method includes for the at least one TRP, a set of basis vectors for the spatial entity and a corresponding set of basis coefficients for the spatial entity is selected, called spatial entity basis coefficients and spatial entity basis vectors, wherein the spatial entity basis vectors are same or different across subbands, and wherein the spatial entity basis vectors is same or different across time.

In an embodiment, the spatial entity basis coefficients for all spatial basis vector is collected across subbands, called as spatial-frequency basis coefficients, wherein the set of spatial-frequency basis coefficients is associated with a set of basis vectors and coefficients, called as spatial-frequency compressed basis coefficient and spatial-frequency compressed basis vectors, wherein each spatial-frequency compressed basis coefficient is collected across time, called as spatial-frequency-time basis coefficients, and wherein each set of spatial-frequency-time basis coefficients is associated with a set of spatial-frequency-time compressed basis vectors and the spatial-frequency-time compressed basis coefficients.

In an embodiment, the UE reports in the CSI report comprising at least one of the spatial entity basis vectors, the spatial-frequency compressed basis vectors, the spatial-frequency-time compressed basis vectors and the spatial-frequency-time compressed basis coefficients for each TRP or any of associated indices for the spatial-frequency compressed basis vectors and the spatial-frequency-time compressed basis vectors.

In an embodiment, the spatial entity basis vectors, the spatial-frequency compressed basis vectors, the spatial-frequency-time compressed basis vectors and the spatial-frequency-time compressed basis coefficients are different for different TRPs.

In an embodiment, the method includes for at least one TRP, a set of basis vectors for the spatial entity and a corresponding set of basis coefficients for the spatial entity is selected, called spatial entity basis coefficients and spatial entity basis vectors, wherein spatial entity basis vectors is same or different across subbands, wherein spatial entity basis vectors is the same or different across time.

In an embodiment, the spatial basis coefficients for each spatial basis vector is collected across subbands and time, called as time-frequency basis coefficients, wherein for each time-frequency basis coefficients for each spatial entity basis vectors is associated with a corresponding set of basis vectors or and basis coefficients, called as time-frequency spatial basis vectors and time-frequency spatial basis coefficients.

In an embodiment, the UE reports in the CSI report comprising at least one of the spatial entity basis vectors, the spatial entity basis coefficients for each subband and across time, the time-frequency spatial basis vectors and time-frequency spatial basis coefficients associated with each of the spatial entity basis vectors, or indices of various basis vectors.

In an embodiment, the CSI report is sent for all TRPs, and wherein the spatial entity basis vectors, the spatial entity basis coefficients are different for different TRPs, the time-frequency spatial basis coefficients is common across TRPs, the time-frequency spatial basis vectors is common across TRPs.

In an embodiment, the method includes for the at least one TRP, a set of basis vectors for the spatial entity and a corresponding set of basis coefficients for the spatial entity is selected, called spatial entity basis coefficients and spatial entity basis vectors, wherein the spatial entity basis vectors are same or different across subbands, wherein spatial entity basis vectors is the same or different across time.

In an embodiment, the spatial basis coefficients for all spatial basis vectors is collected across subbands, called as spatial-frequency basis coefficients, wherein the set of spatial-frequency basis coefficients is associated with a set of basis vectors and coefficients, called as spatial-frequency compressed basis coefficient and spatial-frequency compressed basis vectors, and wherein each of the spatial-frequency compressed basis coefficient is collected across time, called as spatial-frequency-time basis coefficients, and wherein each set of spatial-frequency-time basis coefficients is associated with a set of spatial-frequency-time compressed basis vectors and the spatial-frequency-time compressed basis coefficients.

In an embodiment, the UE reports in the CSI report comprising at least one of the spatial entity basis vectors, the spatial-frequency compressed basis vectors, the spatial-frequency-time compressed basis vectors and the spatial-frequency-time compressed basis coefficients for each TRP.

In an embodiment, the spatial frequency compressed basis vectors are different for different TRPs, spatial frequency time compressed basis coefficients is different across TRPs and spatial frequency time basis vectors is common for all TRPs.

In an embodiment, the basis vectors in the FD and/or the DD is a feedback to the network apparatus (600) or TRP via one or more indices of the basis vectors for each TRP, wherein the indices is common across the TRPs, wherein for each TRP, a rotation factor or offset corresponding to the basis vectors in the FD and/or the DD is sent, and wherein using the rotation factors or the offsets for each TRP and common indices across the TRPs of the basis vectors in the FD and/or the DD, the network apparatus (600) computes the actual basis vectors for each TRP in the FD and/or the DD.

In an embodiment, the basis vectors in the SD, the FD, the DD, is one of DFT basis, oversampled DFT basis, Slepian or discrete prolate spheroidal sequence basis or DCT basis or Karhunen-Love basis.

In another aspect, the embodiment herein is achieved by providing a method for coherent joint transmission in a wireless network system. The method includes sending, by a network apparatus, at least one CSI-RS configuration and at least one corresponding CSI-RS to a UE in the wireless network system. At least one CSI-RS configuration and the at least one corresponding CSI-RS corresponds to at least one TRP out of multiple TRP of the network apparatus. Further, the method includes receiving, by the network apparatus, a CSI report from the UE, wherein the CSI report comprises transmission parameter feedback corresponding to the at least one TRP of multiple TRP of the network apparatus. Further, the method includes precoding, by the network apparatus, in at least one TRP data based on the transmission parameter feedback. Further, the method includes transmitting, by the network apparatus, the pre-coded data in a downlink transmission using the at least one TRP of the multiple TRPs to the UE based on the transmission parameter feedback received from the UE.

Another aspect of the invention is to provide method for channel state information reporting for coherent joint transmission in a wireless network system. The method comprises sending, by a network apparatus, at least one CSI-RS configuration and at least one corresponding CSI-RS to a UE in the wireless network system, wherein the at least one CSI-RS configuration and the at least one corresponding CSI-RS corresponds to at least one TRP out of multiple TRPs of the network apparatus. Further, the method includes receiving, by the network apparatus, a CSI report from the UE, wherein the CSI report comprises transmission parameter feedback corresponding to the at least one TRP of multiple TRP of the network apparatus. Further, the method includes precoding by the network apparatus in at least one TRP data based on the transmission parameter feedback and transmitting by the network apparatus the pre-coded data in a downlink transmission using the at least one TRP of the multiple TRPs to the UE based on the transmission parameter feedback received from the UE.

In an embodiment, precoding, by the network apparatus, data based on the transmission parameter feedback comprises receiving and using, by the network apparatus, spatial entity basis coefficients and the spatial entity basis vectors from the UE for at least one subband and at least one time instant for the at least one TRP of the multiple TRPs based on the transmission parameter feedback. The spatial entity basis vectors and the spatial entity basis coefficients are represents an entity corresponding to the at least one CSI-RS in at least one of a SD, a FD and a doppler or DD for the at least one TRP based on the at least one CSI-RS configuration. Further, the method includes receiving and using, by the network apparatus from UE, at least one of time-frequency spatial basis coefficients, time-frequency spatial basis vectors, spatial frequency compressed basis vectors, spatial frequency time compressed basis vectors, spatial frequency time compressed basis coefficients for at least one TRP. Further, the method includes precoding, by the network apparatus, data based on the spatial entity basis coefficients and the spatial entity basis vectors, time-frequency spatial basis coefficients, time-frequency spatial basis vectors, spatial frequency compressed basis vectors, spatial frequency time compressed basis vectors, spatial frequency time compressed basis coefficients

In an embodiment, the at least one transmission parameter feedback comprises at least one of the basis coefficients in at least one dimension of the SD, the FD and the DD, and indices to determine basis vectors in at least one dimension of the SD, the FD, the DD corresponding to a precoding matrix for at least one TRP of the multiple TRPs.

In an embodiment, the entity is a channel or eigen vector of a channel covariance matrix, and wherein the entity is in spatial domain corresponding to antennas for a given subband and time, called as spatial entity, wherein the spatial entity is processed across subbands for a given time, wherein a subband is a set of contiguous one or more subcarriers in frequency domain, wherein the spatial entity for a particular subband and a particular time is called as spatial-frequency entity, and wherein the spatial-frequency entity is processed across time and is called as spatial-frequency-time entity.

In an embodiment, the basis vectors in the FD and/or the DD is a feedback to the network apparatus (600) or TRP via one or more indices of the basis vectors for each TRP, wherein the indices is common across the TRPs, wherein for each TRP, a rotation factor or offset corresponding to the basis vectors in the FD and/or the DD is sent, and wherein using the rotation factors or the offsets for each TRP and common indices across the TRPs of the basis vectors in the FD and/or the DD, the network apparatus (600) computes the actual basis vectors for each TRP in the FD and/or the DD.

In an embodiment, the basis vectors in the SD, the FD, the DD, is one of DFT basis, oversampled DFT basis, Slepian or discrete prolate spheroidal sequence basis or DCT basis or Karhunen-Love basis.

In yet another aspect of the invention is to provide a UE for channel state information reporting for coherent joint transmission in a wireless network system. The UE includes a memory, a processor, a communicator, and a coherent joint transmission controller, coupled to the memory and the processor. The coherent joint transmission controller receives at least one CSI-RS configuration and at least one corresponding CSI-RS from a network apparatus in the wireless network system, wherein the at least one CSI-RS configuration and one at least one corresponding CSI-RS corresponds to a TRP out of multiple TRPs of the network apparatus. The coherent joint transmission controller selects a set of basis vectors and corresponding basis coefficients, for representing an entity corresponding to each CSI-RS in a SD, a FD and a doppler or DD for each TRP of the multiple TRPs based on the at least one CSI-RS configuration. The entity is a channel or eigen vector of a channel covariance matrix. The coherent joint transmission controller determines at least one transmission parameter feedback corresponding to at least one of the multiple TRPs based on the selected set of basis vectors and basis coefficients that represents the entity in the SD, the FD and the DD. The coherent joint transmission controller transmits a CSI report of the feedback to the network apparatus comprising the at least one transmission parameter corresponding to at least one of the multiple TRPs. Furthers, the coherent joint transmission controller receives downlink transmission from the network apparatus using the at least one TRP based on the transmission parameter feedback.

In yet another aspect of the invention is to provide a network apparatus for channel state information reporting for coherent joint transmission in a wireless communication network system. The network apparatus includes a memory, a processor, a communicator, and a coherent joint transmission controller, coupled to the memory and the processor. The coherent joint transmission controller sends at least one CSI-RS configuration and at least one corresponding CSI-RS to a UE in the wireless network system, wherein the at least one CSI-RS configuration and the at least one corresponding CSI-RS corresponds to at least one TRP out of multiple TRPs of the network apparatus (600). The coherent joint transmission controller receives a CSI report from the UE, wherein the CSI report comprises transmission parameter feedback corresponding to the at least one TRP of multiple TRP of the network apparatus. The coherent joint transmission controller precodes in at least one TRP data based on the transmission parameter feedback, and transmits the pre-coded data in a downlink transmission using the at least one TRP of the multiple TRPs to the UE based on the transmission parameter feedback received from the UE.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications be made within the scope of the embodiments herein.

In essence, CSI pertains to the wireless channel information between a sender and a receiver in a communication system. The latest CSI Release 16 introduces an improved CSI feedback mechanism that compresses the CSI report in the frequency domain. Additionally, it extends the codebook type II to cater to Multiple-Input Multiple-Output (MIMO) channels with a rank greater than two. The ongoing Radio Access Network (RAN) 1 Release-18 is pursuing the CSI type-2 enhancements in various aspects. These include enhancements for single Transmission/Reception Point (TRP) for medium/high velocities, as well as enhancements for multi-TRP Coordinated Joint Transmission (CJT) where Doppler medium/high velocities are not involved.

FIG. 1 illustrates a moving UE with doppler communicating with four TRPs, according to the embodiments as disclosed herein. FIG. 1 describes a moving User Equipment (UE) with the Doppler communicating with four TRPs and in the context the CSI-Type2 feedback to all the TRPs need to be determined. Therefore, there is a need to enhance the CSI-type-2 codebook-based feedback for medium or high velocities for CJT and mTRP.

In an embodiment, given one box for moving UE with the doppler communicating with four TRPs and in the context, the CSI-Type 2 feedback to all the TRPs need to be determined. There is a need to enhance the CSI-type 2 codebook-based feedback for medium or high velocities for CJT and mTRPs.

FIG. 2 is a block diagram that illustrates FD component including Doppler domain (DD) sub-components, according to the embodiments as disclosed herein.

In an embodiment, an existing systems CJT option 1 is described.

$$W = [ \begin{matrix}\begin{matrix}\begin{matrix}{W}_{1 , 1} {\tilde{W}}_{2 , 1} {W}_{f , 1}^{H} \\ {W}_{1 , 2} {\tilde{W}}_{2 , 2} {W}_{f , 2}^{H}\end{matrix} \\ ⋮\end{matrix} \\ {W}_{1 , N} {\tilde{W}}_{2 , N} {W}_{f , N}^{H}\end{matrix} ] \qquad [ Equation 1 ]$$

In an embodiment, Equation 1 is a concatenation of precoder for all subbands per TRP (horizontal concatenation) followed by vertical concatenation across TRPs. Throughout this document W is the precoder calculated at the UE and UE needs to report it to base station (BS) or TRPs. It does not report W directly, It uses codebooks, basis vectors and basis coefficients in dimensions, FD, SD, DD or indices to those basis vectors and reports the indices and basis coefficients, which the BS or TRPs make use to reconstruct the precoder W. The W for prior art or existing systems CJT is across TRPs, for prior art Doppler is for one TRP, for proposed CJT in the context of Doppler is across TRPs.

Furthermore, throughout this document, it is understood that the UE does not feedback the basis vectors across dimensions directly. It feedbacks the indices of basis vectors in each of the dimensions via a codebook.

Where W_{1,i}:Nₜ×2Lᵢ, i=1, 2, 3 . . . . N is the Spatial-Domain (SD) basis set for the ᵢth TRP. Nₜ is number of Tx antennas (including different polarizations, this assumption for number of transmit antennas will hold henceforth). Here i is the TRP index.

Where W_{f,i}:N_{3,i}×M_{v,i} is the Frequency-Domain (FD) basis set for the ᵢth TRP.

Where \tilde{w}_{2,i}: 2Lᵢ×M_{v,i} represents the joint FD coefficients for the ᵢth TRP. In the above for the ith TRP, 2Lᵢ is the no. of spatial basis (columns of W_{1,i}), N_{3,i} is the number of subbands (usually constant for all TRPs).

In an embodiment, the option 1, each TRP can have different M_{v,i} FD basis vectors selected. The reason to select different FD basis vectors is because of different propagation distances from each TRP to UE. This can happen if the TRPs are located in different geography, like inter-site.

In an embodiment, CJT option 2 is described herein according to the embodiments as disclosed herein:

$$W = [ \begin{matrix}{W}_{1 , 1} & & & & \\ & & & ⋯ & \\ & & {W}_{1 , 2} & & \\ & ⋮ & & ⋱ & ⋮ \\ & & & ⋯ & {W}_{1 , N}\end{matrix} ] {\tilde{W}}_{2} {W}_{f}^{H} \qquad [ Equation 2 ]$$

In an embodiment, in this option, common Mᵥ FD basis are selected for each TRP. This usually applies when all TRPs are co-located like intra-site and propagation distance from TRPS to UE (mobile or user equipment) (for example, UE (500)) is roughly constant.

Where W_{1,i}:Nₜ×2Lᵢ, i=1, 2, 3 . . . N is the Spatial-Domain (SD) basis set for the ᵢth TRP. Nₜ is no. of Tx antennas. Here i is the TRP index.

Where W_{f}:N₃×Mᵥ is the Frequency-Domain (FD) basis set for all TRPs.

Where \tilde{W}₂:2Lₜₒₜₐₗ×Mₚ represents the common joint FD basis coefficients for all TRPs. In the above for the ith TRP, 2Lᵢ is the number of spatial basis (columns of W_{1,i}), N₃ is the number of subbands (usually constant for all TRPs) and number of subbands compressed to Mᵥ values. Here Lₜₒₜₐₗ=ΣᵢLᵢ.

In an embodiment, CJT option 3 is described herein according to prior art:

$$W = [ \begin{matrix}\begin{matrix}{W}_{1} \\ ⋮\end{matrix} \\ {W}_{N}\end{matrix} ] = [ \begin{matrix}\begin{matrix}( {W}_{f , 1}^{*} ⊗ {W}_{1 , 1} ) vec ( {\tilde{W}}_{2 , 1} ) . \\ ⋮\end{matrix} \\ ( {W}_{f , N}^{*} ⊗ {W}_{1 , N} ) vec ( {\tilde{W}}_{2 , N} ) .\end{matrix} ] \qquad [ Equation 3 ]$$

Where w=W₁\tilde{W}₂ W_{f}^{H} is equation for One TRP with appropriate dimension. W can also be rewritten as vec(W)=(W_{f}*⊗W₁)vec(\tilde{W}₂). Where vec denotes vectorization. Vec means forming a column vector out of a matrix by stacking the columns of the matrix one after other. E.g.,

$$A = [ \begin{matrix}a & b \\ c & d\end{matrix} ] ,$$

then

$$ν e c ( A ) = [ \begin{matrix}\begin{matrix}\begin{matrix}a \\ c\end{matrix} \\ b\end{matrix} \\ d\end{matrix} ] .$$

For a matrix A, A* means a matrix where each element is the conjugate of the corresponding element in A.

(W_{f}*⊗W₁) denotes a joint space-frequency basis. For all TRPs, stacking the precoder one on another results in (i be the TRP index) in Eq (3).

In an embodiment, CJT option 1 with different embodiment:

$$W = [ \begin{matrix}\begin{matrix}\begin{matrix}{W}_{1 , 1} {\tilde{W}}_{2 , 1} {W}_{f , 1}^{H} {Q}_{1} \\ {W}_{1 , 2} {\tilde{W}}_{2 , 2} {W}_{f , 2}^{H} {Q}_{2}\end{matrix} \\ ⋮\end{matrix} \\ {W}_{1 , N} {\tilde{W}}_{2 , N} {W}_{f , N}^{H} {Q}_{N}\end{matrix} ] \qquad [ Equation 4 ]$$

In an embodiment, in addition to SD and FD basis selection, corresponding to each TRP a complex number Qᵢ is multiplied. The distance to the UE from each TRP is different, leading to a phase shift and amplitude mismatch. Qᵢ compensates for the phase and amplitude mismatch. The Qᵢ can be absorbed in the respective \tilde{W}_{2,i} matrices in which case the Qᵢ becomes as CJT option 1.

In an embodiment, CJT option 4 is described herein. In addition to SD and FD basis selection, corresponding to each TRP a complex diagonal matrix Qᵢ is multiplied. The Qᵢ can also be a non-diagonal matrix. The reference equation is Eq. (4). The distance to UE (500) from each TRP is different, leading to a phase shift and amplitude mismatch. Qᵢ compensates for the phase and amplitude mismatch.

In an embodiment, Prior Art Doppler Option 1:

W=W₁\tilde{W}₂(W_{f}⊗W_{d})^{H}, where W_{d} indicates the Doppler domain (DD) basis matrix, W₁ represents Spatial entity basis vectors, W₂ represents Time frequency spatial basis coefficients, and (W_{f}⊗W_{d})^{H} represents Time frequency spatial basis vectors.

W₁:Nₜ×2L,\tilde{W}₂:2L×MᵥD,W_{f}:N₃×Mᵥ,W_{d}:N₄×D

W_{f}⊗W_{d}:N₃N₄×MᵥD represents all Doppler component for each delay component.

In an embodiment, this is called as W₁ spatial entity basis vectors, \tilde{W}₂ as time frequency spatial basis coefficients and W_{f}⊗W_{d} as time frequency spatial basis vectors.

In an embodiment, the precoders are stacked column-wise, first for a given subband across time instants, and then across subband for all time instants.

FIG. 2 is a block diagram that illustrates FD component including Doppler domain (DD) sub-components, according to the embodiments as disclosed herein. The Doppler option 1 is described herein.

FIG. 3 illustrates a matrices and associated dimensions for Doppler Type-2 CSI feedback for one embodiment, according to various embodiments of the present disclosure.

In an embodiment,

\tilde{W}₂ can be represented as shown in FIG. 3.

In an embodiment, doppler option 2 is described herein. This represents the spatial frequency time compressed basis vectors as follows:

$$W = ( {W}_{f}^{*} ⊗ {W}_{1} ) {\tilde{W}}_{2} {W}_{d}^{H}$$

Further, the spatial frequency compressed basis vector is represented as (W_{f}*⊗W₁):N₃Nₜ×2MᵥL is the joint SD-DD basis. In an embodiment, it is called as spatial frequency compressed basis vector.

Furthermore, the spatial frequency time compressed basis coefficients is presented as \tilde{W}₂:2MᵥL×M_{d}. In an embodiment, it is called as spatial frequency time compressed basis coefficients.

W_{d}:N₄×M_{d}. Here N₄ is number of time instants that is compressed to M_{d}. In an embodiment, it is called spatial frequency time compressed basis vectors.

values. Here in this representation for each time instant, a column vector of the precoder that is vectorised across subbands is computed. All column vectors across various time instants are concatenated horizontally.

FIG. 4 illustrates the matrices and associated dimensions for Doppler Type-2 CSI feedback for another embodiment, according to the embodiments as disclosed herein. FIG. 4 illustrates matrices and associated dimensions for Doppler Type-2 CSI feedback for this embodiment,

In an embodiment, Combined CJT and Doppler option 1 is described:

$$W = [ \begin{matrix}\begin{matrix}\begin{matrix}{W}_{1 , 1} {{\tilde{W}}_{2 , 1} ( {W}_{f , 1} ⊗ {W}_{d , 1} )}^{H} \\ {W}_{1 , 2} {{\tilde{W}}_{2 , 2} ( {W}_{f , 2} ⊗ {W}_{d , 2} )}^{H}\end{matrix} \\ ⋮\end{matrix} \\ {W}_{1 , N} {{\tilde{W}}_{2 , N} ( {W}_{f , N} ⊗ {W}_{d , N} )}^{H}\end{matrix} ] \qquad [ Equation 5 ]$$

In an embodiment, the UE selects different SD (spatial domain), FD (frequency domain) and DD (Doppler or time domain) basis for each TRP, with combined FD and DD coefficients. The precoders for a given TRP are stacked column-wise, first for a given subband across time instants, and then across subband for all time instants. Then precoders for all TRPs are stacked vertically. Let i be the TRP index. Here W_{1,i} is the SD matrix of dimension Nₜ×2Lᵢ, \tilde{W}_{2,i} is combined FD (delay domain) and DD coefficients of dimension 2Lᵢ×MᵥD, W_{f,i}⊗W_{d,i}:N₃N₄×MᵥD represents all Doppler component for each delay component. Note that N₃ subbands compressed to Mᵥ elements and values at N₄ time instants is compressed to D values. For simplicity, it is assumed that N₃, N₄, Mₚ, D to be constant across TRPs. This can be for inter-site TRPs where propagation distance to UE (500) varies considerably.

In an embodiment, for combined CJT and Doppler Option 2

$$W = [ \begin{matrix}\begin{matrix}\begin{matrix}( {W}_{f , 1}^{*} ⊗ {W}_{1 , 1} ) {\tilde{W}}_{2 , 1} {W}_{d , 1}^{H} \\ ( {W}_{f , 2}^{*} ⊗ {W}_{1 , 2} ) {\tilde{W}}_{2 , 2} {W}_{d , 2}^{H}\end{matrix} \\ ⋮\end{matrix} \\ ( {W}_{f , N}^{*} ⊗ {W}_{1 , N} ) {\tilde{W}}_{2 , N} {W}_{d , N}^{H}\end{matrix} ] \qquad [ Equation 6 ]$$

In an embodiment, in this option, UE selects different SD, FD and DD basis for each TRP with joint SD-FD coefficients. Here in this representation for each time instant, a column vector of the precoder that is vectorised across subbands is computed. All column vectors across various time instants are concatenated horizontally. Then a precoder representation per TRP is considered. This is concatenated vertically across all TRPs. Let i be the TRP index.

W_{f,i}⊗W_{1,i}:N₃Nᵢ×2M_{v,i}Lᵢ represents the joint SD-FD basis for each TRP.

In an embodiment, where, \tilde{W}_{2,i} represents the compressed (in Doppler domain) of the coefficients of the joint FD-SD basis across N₄ time instants. It is of dimension 2MᵥLᵢ×Dᵢ, where values at N₄ time instants are compressed to Dᵢ values. Note that N₃ subbands compressed to M_{v,i} elements and values at NA time instants is compressed to Dᵢ values.

W_{d,i}:N₄×Dᵢ. Here N₄ is no. of time instants that is compressed to Dᵢ values. This can be for inter-site TRPs where propagation distance to UE (500) varies considerably.

In an embodiment, the Combined CJT and Doppler is described herein (option 3).

$$W = [ \begin{matrix}{W}_{1 , 1} & & & & \\ & & & ⋯ & \\ & & {W}_{1 , 2} & & \\ & ⋮ & & ⋱ & ⋮ \\ & & & ⋯ & {W}_{1 , N}\end{matrix} ] {{\tilde{W}}_{2} ( {W}_{f} ⊗ {W}_{d} )}^{H} \qquad Eq . 7$$

In this option, UE selects different SD basis for each TRP, and common FD and DD basis among TRPs, with joint FD-DD compression.

Let i be the TRP index. W_{1,i}:Nₜ×2Lᵢ, i=1, 2, 3 . . . . N is the Spatial-Domain (SD) basis set for the ᵢth TRP.

2Lᵢ is the number of spatial basis (columns of W_{1,i}), Nₜ is number of Tx antennas. \tilde{W}₂:2Lₜₒₜₐₗ×MᵥD is the common basis set for all TRPs. Here Lₜₒₜₐₗ=ΣᵢLᵢ.

W_{f}⊗W_{d}:N₃N₄×MᵥD represents all Doppler component for each delay component. N₃ is the number of subbands (usually constant for all TRPs) and no. of subbands compressed to Mᵥ values. Note that N₄ time instants is compressed to D values.

In an embodiment, the precoders for a given TRP are stacked column-wise, first for a given subband across time instants, and then across subband for all time instants. Then precoders for all TRPs are stacked vertically.

In an embodiment, the combined CJT and Doppler (option 4):

$$W = [ \begin{matrix}( {W}_{f , 1}^{*} ⊗ {W}_{1 , 1} ) & & & & \\ & & & ⋯ & \\ & & ( {W}_{f , 2}^{*} ⊗ {W}_{1 , 2} ) & & \\ & ⋮ & & ⋱ & ⋮ \\ & & & ⋯ & ( {W}_{f , N}^{*} ⊗ {W}_{1 , N} )\end{matrix} ] {\tilde{W}}_{2} {W}_{d}^{H} \qquad Eq . 8$$

In another embodiment in this option, different SD-FD basis selection for each TRP. DD basis are common among TRPs with joint SD-FD compression.

W_{f,i}⊗W_{1,i}:N₃Nₜ×2MᵥLᵢ represents the joint SD-FD basis for each TRP. W_{1,i}:Nₜ×2Lᵢ, i=1, 2, 3 . . . N is the Spatial-Domain (SD) basis set for the ᵢth TRP. 2Lᵢ is the no. of spatial basis (columns of W_{1,i}), Nₜ is no. of Tx antennas.

W_{f,i}:N₃×M_{v,i} represents the FD basis for the ᵢth TRP. N₃ is the number of subbands (usually constant for all TRPs) and no. of subbands compressed to M_{v,i} values. In the above for the ith TRP, 2Lᵢ is the no. of spatial basis (columns of W_{1,i}), N_{3,i} is the number of subbands (usually constant for all TRPs). \tilde{W}₂ is the 2MᵥLₜₒₜₐₗ×D joint SD-FD-DD basis coefficients.

W_{d}:N₄×M_{d}. Here N₄ is no. of time instants that is compressed to Ma values.

In another embodiment, in option 5 of combined CJT and Doppler.

W=W₁\tilde{W}₂(W_{f}⊗W_{d})^{H}

The common SD, FD and DD components are selected among TRPs with joint FD-DD compression. Here W₁ is SD basis across TRPs of dimension NNₜ×2L where N is no. of TRPs, Nₜ is no. of antennas, L is no. of spatial dimensions per polarization. \tilde{W}₂:2L×MᵥD, W_{f}:N₃×Mₚ, W_{d}:N₄×D. The precoders per TRP are formed as follows. The precoders are stacked column-wise, first for a given subband across time instants, and then across subband for all time instants. The precoders across all TRPs are then stacked vertically.

In another embodiment, Option 6 for combined CJT and Doppler:

$$W = ( {W}_{f}^{*} ⊗ {W}_{1} ) {\tilde{W}}_{2} {W}_{d}^{H}$$

In this option, common SD, FD and DD components are selected with joint SD-FD compression. This is just rewriting Option 5 in a different form.

In another embodiment, CJT and Doppler options 1, 2 and 4 which has separate FD basis

$${W}_{f , i}^{}$$

basis
a. replaced

$${W}_{f , i}^{} by {Q}_{i} {W}_{f , i}^{}$$

where
i. Qᵢ can be any complex matrix,
ii. Qᵢ can be any complex diagonal matrix
iii. Qᵢ can be any scaled identity matrix
iv. Qᵢ can be a diagonal complex exponential.
v. Qᵢ can be a diagonal complex exponential such that

$${Q}_{i} {W}_{f , i}^{}$$

is an oversampled DFT basis.

In another embodiment, CJT and Doppler options 3, 4 and 6 includes a common FD

$${W}_{f}^{□}$$

basis:
b. replaced we by

$${W}_{f}^{□} by {Q}_{□} {W}_{f}^{□}$$

where
i. Q_{□} can be any complex matrix,
ii. Q_{□} can be any complex diagonal matrix
iii. Q_{□} can be any scaled identity matrix
iv. Q_{□} can be a diagonal complex exponential.
v. Q_{□} can be a diagonal complex exponential such that

$${Q}_{□} {W}_{f}^{□}$$

is an oversampled DFT basis.

In an embodiment, Delay-Doppler, Frequency-Time is described herein. In the equivalence of delay-frequency, Doppler-time is in context of channel but channel could also mean elements of \tilde{W}₂ or W₂ across tome or frequency.

In another embodiment, Delay-Frequency is described herein:

In a less frequency selective channel, variation of channel h (of length N) is gradual with frequency. Taking FFT of h gives delay components.

If h is multiplied by a complex exponential

$$[ 1 exp ( \frac{j 2 π k 1}{N} ) exp ( \frac{j 2 π k 2}{N} ) … exp ( \frac{j 2 π k ( N - 1 )}{N} ) ] ,$$

where k is an integer and N is the number of sub-carriers, the delay components are offset/rotated. This is depicted in FIG. 9 and FIG. 10.

If k is a fraction <1, in

$${h}_{k} = [ 1 exp ( \frac{j 2 π k 1}{N} ) exp ( \frac{j 2 π k 2}{N} ) … exp ( \frac{j 2 π k ( N - 1 )}{N} ) ] ,$$

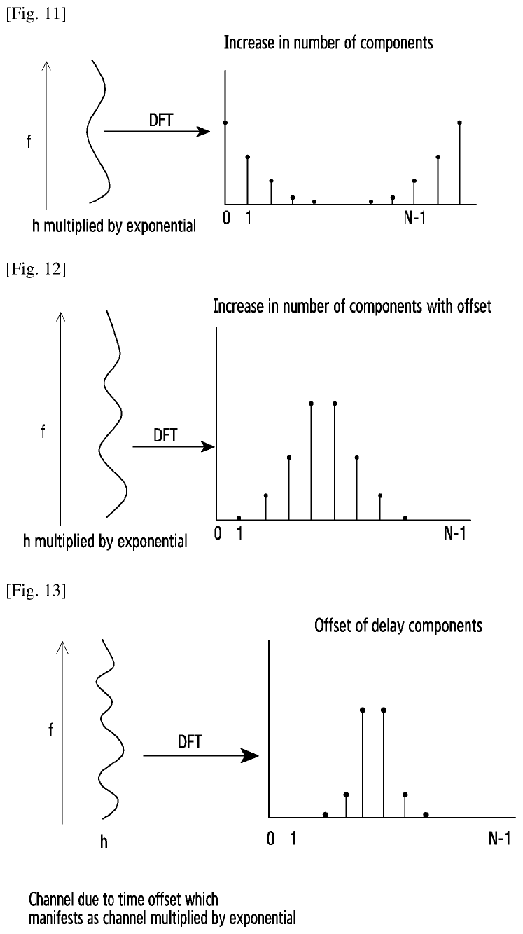

there is an increase in the number of components in h⊙hₖ, where ⊙ is an element-wise multiplication operator. This is shown in FIG. 9 and FIG. 11.

If k is a fraction >1, in

$${h}_{k} = [ 1 exp ( \frac{j 2 π k 1}{N} ) exp ( \frac{j 2 π k 2}{N} ) … exp ( \frac{j 2 π k ( N - 1 )}{N} ) ] ,$$

there is an increase in the number of components in h⊙hₖ, also a shift or offset, where ⊙ is an element-wise multiplication operator. This is shown in FIG. 9 and FIG. 12.

FIG. 5 illustrates a block diagram of a UE (500) for CSI reporting for CJT in a wireless communication network system, according to the embodiments as disclosed herein. The UE (500) includes a processor (501), a memory (502), a communicator (503) and a coherent joint transmission controller (504).

In an embodiment, the UE (500) acts as an end-user device capable of connecting to the wireless communication network system for the purpose of accessing services. This device can take various forms, including but not limited to a mobile phone, a smart phone, tablets, laptops, and Internet of Thing (IoT) devices. Essentially, ant device that can connect to the wireless communication network system and access services can be considered a UE (500).

Further, the processor (502) communicates with the memory (501), the communicator (503), the coherent joint transmission controller (504). The processor (502) can include one or a plurality of processors (502), can be a general-purpose processor (502), such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU). Further, the memory of the UE (500) includes storage locations to be addressable through the processor (502). The memory (501) is not limited to a volatile memory (501) and/or a non-volatile memory (501). Further, the memory (501) can include one or more computer-readable storage media. The memory (501) can include non-volatile storage elements. For example, non-volatile storage elements can include magnetic hard discs, optical discs, floppy discs, flash memories, or forms of electrically programmable memories (EPROM) or electrically erasable and programmable (EEPROM) memories. The memory (501) stores the information about a network apparatus (600) and information received from the network apparatus (600) such as CSI, basis vectors, corresponding coefficients etc.

The communicator (503) serves as the intermediary for transmitting information between the memory (501) and the external peripheral devices which are the input-output devices associated with the UE (500). The communicator (503) not only receives multiple information from the network, but also possess additional resources, such as buffers, impedance. For instance, input devices such as a keyboard and mouse provide data to the computer while output devices such as a monitor and printer display and print information respectively.

In an embodiment, the coherent joint transmission controller (504) is an innovative hardware that is implemented through the physical implementation of both analog and digital circuits, including logic gates, integrated circuits, microprocessors, microcontrollers, memory circuits, passive and active electronic components, as well as optical components.

In an embodiment, the coherent joint transmission controller (504) is connected to the memory (502) and the processor (501). The coherent joint transmission controller (504) receives at least one CSI-RS configuration and at least one corresponding CSI-RS from a network apparatus (600) in the wireless communication network system. The at least one CSI-RS configuration and one at least one corresponding CSI-RS corresponds to a TRP out of multiple TRPs of the network apparatus (600). Further, the coherent joint transmission controller (504) selects a set of basis vectors and corresponding basis coefficients, for representing an entity corresponding to each CSI-RS in a SD, a FD and a doppler or DD for each TRP of the multiple TRPs based on the at least one CSI-RS configuration. The entity is a channel or eigen vector of a channel covariance matrix.

In an embodiment, the entity is in spatial domain corresponding to antennas for a given subband and time, called as spatial entity, wherein the spatial entity is processed across subbands for a given time, wherein a subband is a set of contiguous one or more subcarriers in frequency domain, wherein the spatial entity for a particular subband and a particular time is called as spatial-frequency entity, and wherein the spatial-frequency entity is processed across time and is called as spatial-frequency-time entity.

Further, the coherent joint transmission controller (504), determines at least one transmission parameter feedback corresponding to at least one of the multiple TRPs based on the selected set of basis vectors and basis coefficients that represents the entity in the SD, the FD and the DD. Further, the coherent joint transmission controller (504), transmits a CSI report of the feedback to the network apparatus (600). The CSI report includes the at least one transmission parameter corresponding to at least one of the multiple TRPs. Further, the coherent joint transmission controller (504), receives downlink transmission from the network apparatus (600) using the at least one TRP based on the transmission parameter feedback.

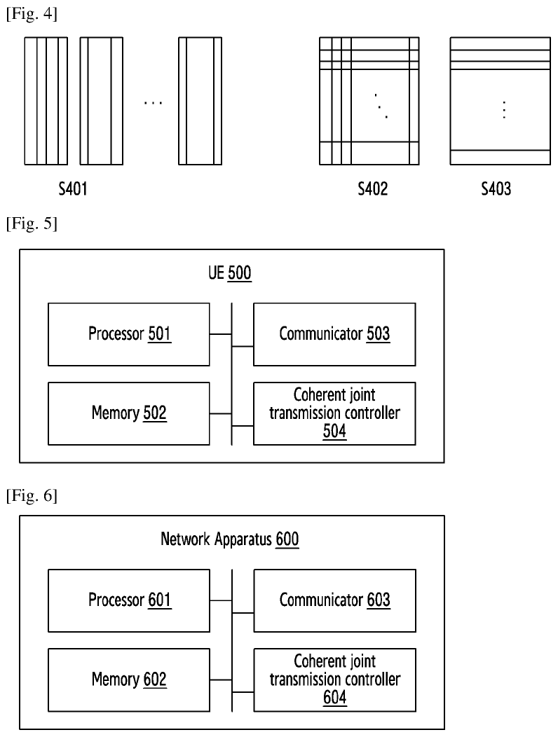

FIG. 6 illustrates a block diagram of the network apparatus (600) for CSI reporting for CJT in a wireless communication network system, according to the embodiments as disclosed herein. The network apparatus (600) includes a memory (601), a processor (602), a communicator (603), and a coherent joint transmission controller (604).

In an embodiment, the coherent joint transmission controller (604) is connected to the memory (601) and the processor (602). The coherent joint transmission controller (604) sends at least one CSI-RS configuration and at least one corresponding CSI-RS to the UE (500) in the wireless network system. The at least one CSI-RS configuration and the at least one corresponding CSI-RS corresponds to at least one TRP out of multiple TRP of the network apparatus (600). Further, the coherent joint controller receives a CSI report from the UE (500). The CSI report comprises transmission parameter feedback corresponding to the at least one TRP of multiple TRP of the network apparatus (600). In an embodiment, the transmission parameter feedback comprises at least one of the basis coefficients in at least one dimension of the SD, the FD and the DD, and indices to determine basis vectors in at least one dimension of the SD, the FD, the DD corresponding to a precoding matrix for at least one TRP of the multiple TRPs

Further, the coherent joint controller (604) precedes in at least one TRP data based on the transmission parameter feedback. In an embodiment, the precoding includes receiving and using, by the network apparatus (600), spatial entity basis coefficients and the spatial entity basis vectors from the UE (500) for at least one subband and at least one time instant for the at least one TRP of the multiple TRPs based on the transmission parameter feedback. The spatial entity basis vectors and the spatial entity basis coefficients are represents an entity corresponding to the at least one CSI-RS in at least one of a SD, a FD and a DD for the at least one TRP based on the at least one CSI-RS configuration. Further, the coherent joint controller (604) receives and uses at least one of time-frequency spatial basis coefficients, time-frequency spatial basis vectors, spatial frequency compressed basis vectors, spatial frequency time compressed basis vectors, spatial frequency time compressed basis coefficients for at least one TRP. Further, the coherent joint controller (604) precodes data based on the spatial entity basis coefficients and the spatial entity basis vectors, time-frequency spatial basis coefficients, time-frequency spatial basis vectors, spatial frequency compressed basis vectors, spatial frequency time compressed basis vectors, spatial frequency time compressed basis coefficients.

In an embodiment, the entity is a channel or eigen vector of a channel covariance matrix, and wherein the entity is in spatial domain corresponding to antennas for a given subband and time, called as spatial entity, wherein the spatial entity is processed across subbands for a given time, wherein a subband is a set of contiguous one or more subcarriers in frequency domain, wherein the spatial entity for a particular subband and a particular time is called as spatial-frequency entity, and wherein the spatial-frequency entity is processed across time and is called as spatial-frequency-time entity.

Furthermore, the coherent joint controller (604) transmits the pre-coded data in a downlink transmission using the at least one TRP of the multiple TRPs to the UE (500) based on the transmission parameter feedback received from the UE (500).

In an embodiment, the basis vectors in the FD and/or the DD is a feedback to the network apparatus (600) or TRP via one or more indices of the basis vectors for each TRP, wherein the indices is common across the TRPs, wherein for each TRP, a rotation factor or offset corresponding to the basis vectors in the FD and/or the DD is sent, and wherein using the rotation factors or the offsets for each TRP and common indices across the TRPs of the basis vectors in the FD and/or the DD, the network apparatus (600) computes the actual basis vectors for each TRP in the FD and/or the DD.

In an embodiment, the basis vectors in the SD, the FD, the DD, is one of DFT basis, oversampled DFT basis, Slepian or discrete prolate spheroidal sequence basis or DCT basis or Karhunen-Love basis.

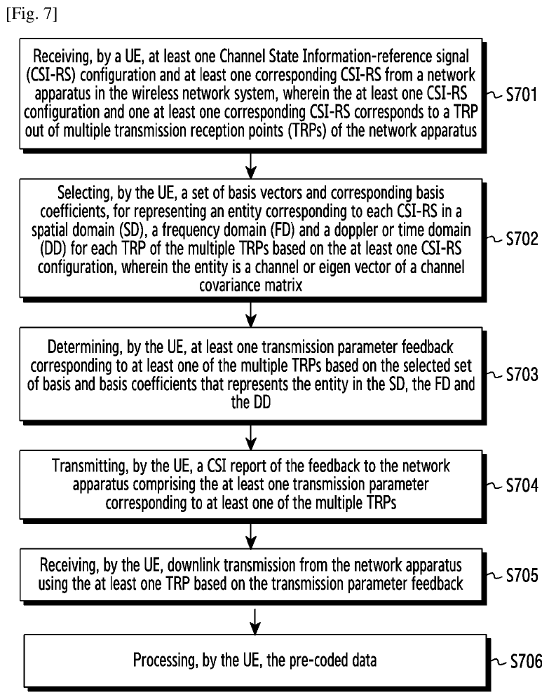

FIG. 7 is a flow chart that illustrates a scenario for CSI reporting for CJT in a wireless communication network system, by a UE (500), according to the embodiments as disclosed herein.

At S701, the method includes receiving, at least one CSI-RS configuration and at least one corresponding CSI-RS from the network apparatus (600) in the wireless communication network system. The at least one CSI-RS configuration and one at least one corresponding CSI-RS corresponds to a TRP out of multiple TRPs of the network apparatus (600).

At S702, the method includes selecting a set of basis vectors and corresponding basis coefficients, for representing an entity corresponding to each CSI-RS in a spatial domain (SD), a frequency domain (FD) and a doppler or a doppler or time domain (DD) for each TRP of the multiple TRPs based on the at least one CSI-RS configuration. The entity is a channel or eigen vector of a channel covariance matrix.

In an embodiment, the entity is in spatial domain corresponding to antennas for a given subband and time, called as spatial entity, wherein the spatial entity is processed across subbands for a given time, wherein a subband is a set of contiguous one or more subcarriers in frequency domain, wherein the spatial entity for a particular subband and a particular time is called as spatial-frequency entity, and wherein the spatial-frequency entity is processed across time and is called as spatial-frequency-time entity.

At S703, the method includes determining at least one transmission parameter feedback corresponding to at least one of the multiple TRPs based on the selected set of basis vectors and basis coefficients that represents the entity in the SD, the FD and the DD. In an embodiment, the transmission parameter feedback includes at least one of the basis coefficients in at least one dimension of the SD, the FD and the DD, and indices to determine basis vectors in at least one dimension of the SD, the FD, the DD corresponding to a precoding matrix for at least one TRP of the multiple TRPs.

At S704, the method includes transmitting a CSI report of the feedback to the network apparatus (600). The CSI report include the at least one transmission parameter corresponding to at least one of the multiple TRPs.

At S705, the method includes receiving downlink transmission from the network apparatus (600) using the at least one TRP based on the transmission parameter feedback.

At S706, the method includes processing the pre-coded data. In an embodiment, the method includes receiving a pre-coded data from the network apparatus (600). The network apparatus (600) pre-codes data using the at least one transmission parameter. Further, the method includes decoding the pre-coded data received from the network apparatus (600).

In an embodiment, the at least one transmission parameter feedback comprises at least one of the basis coefficients in at least one dimension of the SD, the FD and the DD, and indices to determine the basis vectors in at least one dimension of SD, FD, DD corresponding to a precoding matrix for at least one TRP of the multiple TRPs.

In an embodiment, for the at least one TRP, a set of basis vectors for the spatial entity and a corresponding set of basis coefficients for the spatial entity is selected, called spatial entity basis coefficients and spatial entity basis vectors, wherein the spatial entity basis vectors is same or different across sub bands, wherein the spatial entity basis vectors is the same or different across time.

In an embodiment, the spatial entity basis coefficients for each spatial basis vector are collected across subbands and time, called as time-frequency basis coefficients, wherein for each set of time-frequency basis coefficients for each spatial entity basis vectors is associated with a corresponding set of basis vectors and basis coefficients, called as time-frequency spatial basis vectors and time-frequency spatial basis coefficients.

In an embodiment, the UE (500) reports in the CSI report comprising at least one of the spatial entity basis vectors, the spatial entity basis coefficients for each subband and across time, the time-frequency spatial basis vectors and time-frequency spatial basis coefficients associated with each of the spatial entity basis vectors, indices of various basis vectors.

In an embodiment, the CSI report is sent for all TRPs, and wherein the spatial entity basis vectors, the spatial entity basis coefficients, the time-frequency spatial basis vectors, and the time-frequency spatial basis coefficients are different for different TRPs.

In an embodiment, for the at least one TRP, a set of basis vectors for the spatial entity and a corresponding set of basis coefficients for the spatial entity is selected, called spatial entity basis coefficients and spatial entity basis vectors, wherein the spatial entity basis vectors is same or different across subbands, and wherein the spatial entity basis vectors is same or different across time.

In an embodiment, the spatial entity basis coefficients for all spatial basis vector is collected across subbands, called as spatial-frequency basis coefficients, wherein the set of spatial-frequency basis coefficients is associated with a set of basis vectors and coefficients, called as spatial-frequency compressed basis coefficient and spatial-frequency compressed basis vectors, wherein each spatial-frequency compressed basis coefficient is collected across time, called as spatial-frequency-time basis coefficients, and wherein each set of spatial-frequency-time basis coefficients is associated with a set of spatial-frequency-time compressed basis vectors and the spatial-frequency-time compressed basis coefficients.

In an embodiment, the UE (500) reports in the CSI report comprising at least one of the spatial entity basis vectors, the spatial-frequency compressed basis vectors, the spatial-frequency-time compressed basis vectors and the spatial-frequency-time compressed basis coefficients for each TRP or any of associated indices for the spatial-frequency compressed basis vectors and the spatial-frequency-time compressed basis vectors.

In an embodiment, the spatial entity basis vectors, the spatial-frequency compressed basis vectors, the spatial-frequency-time compressed basis vectors and the spatial-frequency-time compressed basis coefficients are different for different TRPs.

In an embodiment, for at least one TRP, a set of basis vectors for the spatial entity and a corresponding set of basis coefficients for the spatial entity is selected, called spatial entity basis coefficients and spatial entity basis vectors, wherein spatial entity basis vectors is same or different across subbands, wherein spatial entity basis vectors is the same or different across time.

In an embodiment, the spatial entity basis coefficients for each spatial basis vector is collected across subbands and time, called as time-frequency basis coefficients, wherein for each time-frequency basis coefficients for each spatial entity basis vectors is associated with a corresponding set of basis vectors or and basis coefficients, called as time-frequency spatial basis vectors and time-frequency spatial basis coefficients.

In an embodiment, the UE (500) reports in the CSI report comprising at least one of the spatial entity basis vectors, the spatial entity basis coefficients for each subband and across time, the time-frequency spatial basis vectors and time-frequency spatial basis coefficients associated with each of the spatial entity basis vectors, or indices of various basis vectors.

The CSI report is sent for all TRPs, and wherein the spatial entity basis vectors, the spatial entity basis coefficients are different for different TRPs, the time-frequency spatial basis coefficients is common across TRPs, the time-frequency spatial basis vectors is common across TRPs.

In an embodiment, for the at least one TRP, a set of basis vectors for the spatial entity and a corresponding set of basis coefficients for the spatial entity is selected, called spatial entity basis coefficients and spatial entity basis vectors, wherein the spatial entity basis vectors is same or different across subbands, wherein spatial entity basis vectors is the same or different across time.

In an embodiment, the spatial basis coefficients for all spatial basis vectors is collected across subbands, called as spatial-frequency basis coefficients, wherein the set of spatial-frequency basis coefficients is associated with a set of basis vectors and coefficients, called as spatial-frequency compressed basis coefficient and spatial-frequency compressed basis vectors, and wherein each of the spatial-frequency compressed basis coefficient is collected across time, called as spatial-frequency-time basis coefficients, and wherein each set of spatial-frequency-time basis coefficients is associated with a set of spatial-frequency-time compressed basis vectors and the spatial-frequency-time compressed basis coefficients.

In an embodiment, the UE (500) reports in the CSI report comprising at least one of the spatial entity basis vectors, the spatial-frequency compressed basis vectors, the spatial-frequency-time compressed basis vectors and the spatial-frequency-time compressed basis coefficients for each TRP.

In an embodiment, the spatial frequency compressed basis vectors are different for different TRPs, spatial frequency time compressed basis coefficients are different across TRPs and spatial frequency time basis vectors is common for all TRPs.

In an embodiment, the basis vectors in the FD and/or the DD is a feedback to the network apparatus (600) or TRP via one or more indices of the basis vectors for each TRP, wherein the indices is common across the TRPs, wherein for each TRP, a rotation factor or offset corresponding to the basis vectors in the FD and/or the DD is sent, and wherein using the rotation factors or the offsets for each TRP and common indices across the TRPs of the basis vectors in the FD and/or the DD, the network apparatus (600) computes the actual basis vectors for each TRP in the FD and/or the DD.

In an embodiment, the basis vectors in the SD, the FD, the DD, is one of DFT basis, oversampled DFT basis, Slepian or discrete prolate spheroidal sequence basis or DCT basis or Karhunen-Love basis.

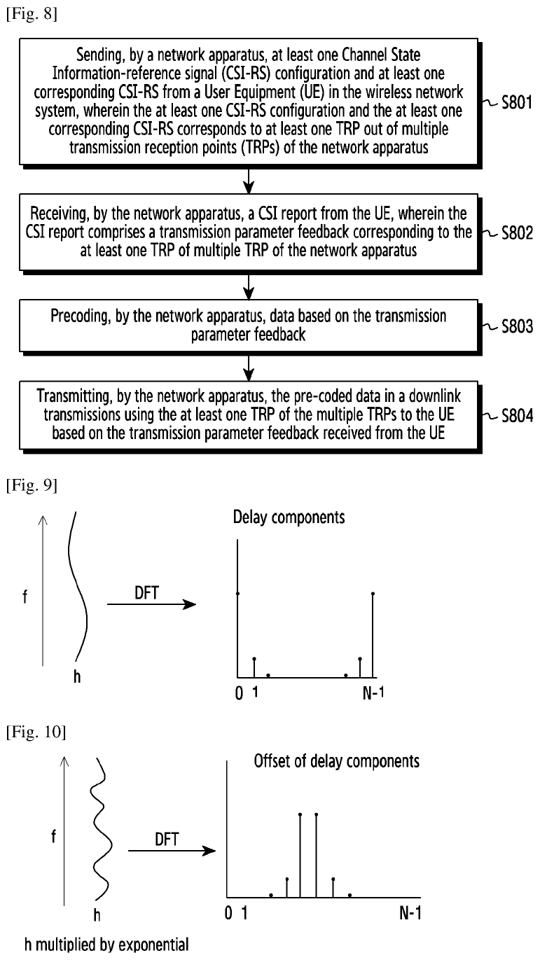

FIG. 8 is a flow chart that illustrates a scenario for CSI reporting for CJT in a wireless communication network system, by the network apparatus (600), according to the embodiments as disclosed herein.

At S801, the method includes sending at least one CSI-RS configuration and at least one corresponding CSI-RS to a UE (500) in the wireless network system. The at least one CSI-RS configuration and the at least one corresponding CSI-RS corresponds to at least one TRP out of multiple TRPs of the network apparatus (600).

At S802, the method includes receiving a CSI report from the UE (500). The CSI report includes the transmission parameter feedback corresponding to the at least one TRP of multiple TRP of the network apparatus (600).

At S803, the method includes precoding in at least one TRP data based on the transmission parameter feedback.

At S804, the method includes transmitting the pre-coded data in a downlink transmission using the at least one TRP of the multiple TRPs to the UE (500) based on the transmission parameter feedback received from the UE (500).

In an embodiment, precoding data based on the transmission parameter feedback includes receiving and using spatial entity basis coefficients and the spatial entity basis vectors from the UE (500) for at least one subband and at least one time instant for the at least one TRP of the multiple TRPs based on the transmission parameter feedback, wherein the spatial entity basis vectors and the spatial entity basis coefficients are represents an entity corresponding to the at least one CSI-RS in at least one of a SD, a FD and a DD for the at least one TRP based on the at least one CSI-RS configuration.

Further, the method includes receiving and using, by the network apparatus (600) from UE (500), at least one of time-frequency spatial basis coefficients, time-frequency spatial basis vectors, spatial frequency compressed basis vectors, spatial frequency time compressed basis vectors, spatial frequency time compressed basis coefficients for at least one TRP. Further, the method includes precoding, by the network apparatus (600), data based on the spatial entity basis coefficients and the spatial entity basis vectors, time-frequency spatial basis coefficients, time-frequency spatial basis vectors, spatial frequency compressed basis vectors, spatial frequency time compressed basis vectors, spatial frequency time compressed basis coefficients.

In an embodiment, the at least one transmission parameter feedback comprises at least one of the basis coefficients in at least one dimension of the SD, the FD and the DD, and indices to determine basis vectors in at least one dimension of the SD, the FD, the DD corresponding to a precoding matrix for at least one TRP of the multiple TRPs.

In an embodiment, the entity is a channel or eigen vector of a channel covariance matrix, and wherein the entity is in spatial domain corresponding to antennas for a given subband and time, called as spatial entity, wherein the spatial entity is processed across subbands for a given time, wherein a subband is a set of contiguous one or more subcarriers in frequency domain, wherein the spatial entity for a particular subband and a particular time is called as spatial-frequency entity, and wherein the spatial-frequency entity is processed across time and is called as spatial-frequency-time entity.

In an embodiment, the basis vectors in the FD and/or the DD is a feedback to the network apparatus (600) or TRP via one or more indices of the basis vectors for each TRP, wherein the indices is common across the TRPs, wherein for each TRP, a rotation factor or offset corresponding to the basis vectors in the FD and/or the DD is sent, and wherein using the rotation factors or the offsets for each TRP and common indices across the TRPs of the basis vectors in the FD and/or the DD, the network apparatus (600) computes the actual basis vectors for each TRP in the FD and/or the DD.

In an embodiment, the basis vectors in the SD, the FD, the DD, is one of DFT basis, oversampled DFT basis, Slepian or discrete prolate spheroidal sequence basis or DCT basis or Karhunen-Love basis.

FIG. 9 is a graph that illustrates delay components obtained by taking DFT of a channel across subcarriers, according to the embodiments disclosed herein.

FIG. 10 is a graph that illustrates offset of delay component obtained by taking DFT of a channel that was multiplied by a complex exponential, according to the embodiments disclosed herein.

FIG. 11 is a graph that illustrates increase in number of delay components when a channel is multiplied by a complex exponential where the normalized digital frequency of the complex exponential is less than unity, according to the embodiments disclosed herein.

FIG. 12 is graph that illustrates increase in number of delay components with offset, when a channel is multiplied by a complex exponential where the normalized digital frequency of the complex exponential is greater than unity and not an integer, according to the embodiments disclosed herein.

FIG. 13 is a graph that illustrates offset of delay components, when DFT of a channel is taken, where the channel has a time offset that manifests itself as a complex exponential, according to the embodiments disclosed herein.

In an embodiment, these delay components correspond to rows of

$${W}_{f}^{H}$$

of a TRP. In option 1 of CJT, rather than having different

$${W}_{f , i}^{H}$$

for each TRP, a common

$${W}_{f}^{H}$$

can be reported along with the offset corresponding to the delay difference between TRPs. This is shown in FIG. 9 and FIG. 13. In FIG. 13, Channel due to time offset which manifests as channel multiplied by exponential.

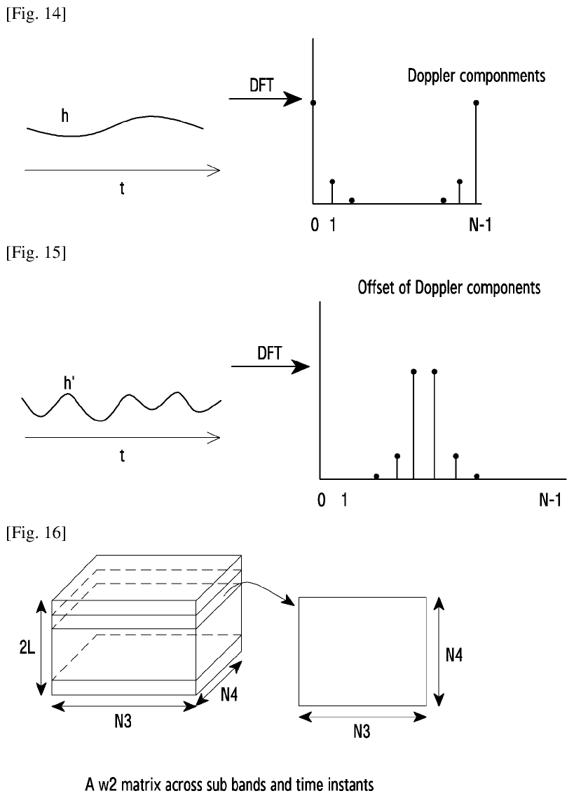

FIG. 14 is a graph that illustrates doppler components, when DFT of a channel across time is taken according to the embodiments disclosed herein.

FIG. 15 is a graph that illustrates offset in Doppler components, when DFT of a channel across time is taken according, when the channel has been multiplied by a Doppler/residual frequency whose normalized digital frequency is an integer, according to the embodiments disclosed herein.

In an embodiment, similarly, multiplying a time varying channel by a complex exponential shifts/rotates the Doppler components. The Doppler components correspond to the rows of

$${W}_{d}^{H} .$$

Similar to the delay-frequency, the complex exponential frequency k can be an integer, fraction <1, of a fraction >1 (like 2.5 for example). Doppler arises due to movement of UE (500) and local oscillator carrier frequency mismatches.

| Option | W_{f} | W_{d} |
|---|---|---|
| 1 | Offset independently | Offset independently |
| | selected for each TRP | selected for each TRP |
| 2 | Offset independently | Common offsets across |
| | selected for each TRP | TRPs |
| 3 | Common offsets across | Offset independently |
| | TRPs | selected for each TRP |
| 4 | Common offsets across | Common offsets across |
| | TRPs | TRPs |

In codebook options for CJT-Doppler where there is different FD and DD components selected for each TRP, a rotation factor can be reported corresponding to each TRP and FD/DD basis components can be kept common.

A rotation by

$$[ 1 exp ( \frac{j 2 π k 1}{N} ) exp ( \frac{j 2 π k 2}{N} ) … exp ( \frac{j 2 π k ( N - 1 )}{N} ) ]$$

factor shifts the FD/DD components of a TRP to align with the FD/DD components of a reference TRP. The rotation factor k must be reported for each TRP along with the indices. Here k is complex exponential frequency, can be <1, >1 ort an integer.

Basis options for W₁, W_{f}, W_{d}.

Each of the basis set in frequency, time (Doppler), spatial can be selected from DFT, oversampled DFT, Slepian (discrete prolate spheroidal sequence), Polynomial basis, Karhunen-Loeve, DCT or any other basis.

In the options where the offsets in W_{f}, W_{d} are to be reported, then W_{f} or W_{d} are selected from DFT basis set. DFT can be oversampled DFT too

FIG. 16 is a 2D matrix slice across subbands and time instants, obtained from slicing a 3D matrix across spatial, frequency and time dimensions, according to the embodiments disclosed herein.

In an embodiment, the generalized Methods: Options 1-4 for proposed CJT+Doppler can be generalized as below.

In another embodiment, Slices from W2:

For each TRP (neglecting TRP index i) W₂ (or \tilde{W}₂) matrix concatenated horizontally across subbands (or delays) to form a 2D matrix. 2D matrix can be concatenated in a third dimension (pages) across time. This gives a 3D matrix as shown below. Here 2L is no. of spatial basis (columns of W₁, N₃ no. of subbands and N₄ is no. of time instants. N₃ can be replaced by no. of delays and N₄ can be replaced by number of Doppler elements D. A 2D slice can be in vertical direction (another embodiment) as well, i.e., N4 2D slices of dimension 2L×N₃. In the figure shown the slice is horizontal.

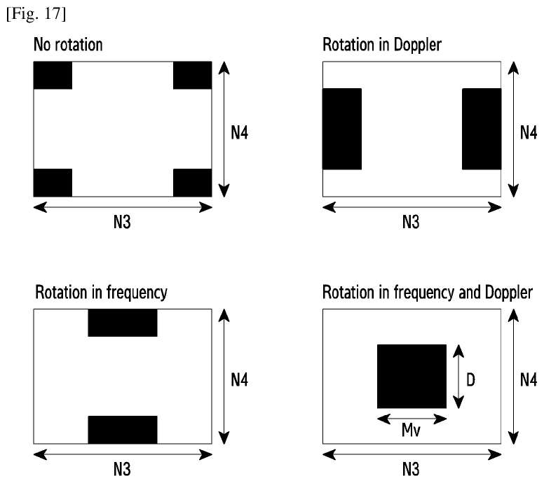

FIG. 17 is a block diagram that illustrates 2D FFT, of a slice of channel in frequency and time, according to the embodiments disclosed herein.

In an embodiment, Slices from W2:W2 SD compression of W from Nt to 2L. Take 2D DFT of each slice of size N₃×N4 as shown in figure below. The 2D FFT can result different options of rotation in only frequency, only Doppler and both frequency and Doppler. This will do FD-DD compression from N3N4 to MvD. The blue region in FIG. 17 is the one with appreciable energy and needs to be reported (compression achieved). While the figure on the right is depicted for 2D FFT, a similar figure is achieved when a slice is projected onto a 2D basis as well, and the 2D basis coefficients of a slice is reported with appreciable energy only. The 2D basis can be oversampled DFT, Slepian, Polynomial, DCT or Karhunen-love transform or other basis. Each compressed slice is reported back for all 2L slices. This is per TRP. This is repeated for all TRPs. The blue region can be feedback by reporting the corner indices of the blue region (under modulo) or each of the bins in the blue region can be reported separately, or a common set of bin indices and rotation offsets for both dimensions for each TRP.

In another embodiment, Slices from W2: In a similar way,
i. A slices of size 2L×N4 can be taken corresponding to spatial and time dimensions for various subbands.
ii. A slices of size 2L×N₃ can be taken corresponding to spatial and subband dimensions for various time instants.

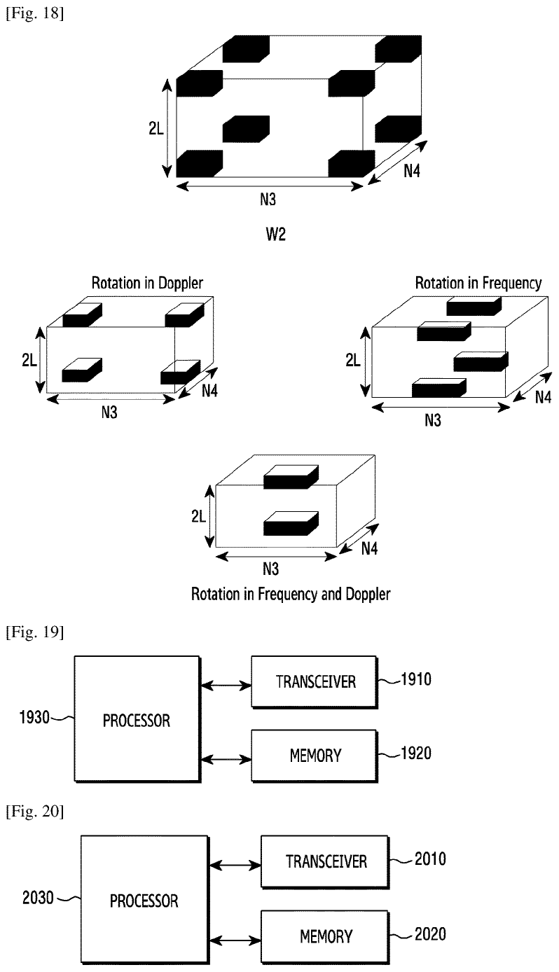

FIG. 18 is a block diagram that illustrates DFT or projecting to a 3D basis of a channel across spatial, frequency and time, with three options for rotation, according to the embodiments disclosed herein.

In an embodiment, W2: 2L×N₃×N₄ can be compressed using 3D DFT or projecting to a 3D basis with three options for rotation: only in frequency, only in doppler, in both frequency and doppler. Reporting of bins can be done in two ways
block-wise reporting requires the start bin and size of the block to be reported.
Else, individual bins can be reported.

In another embodiment, 2D basis coefficients of a Slice:

Assume the Slice is of dimension N₃×N₄ and is denoted by S. The 2D basis coefficients of the Slice, denoted by S_{f}. The (m,n)^{th} basis coefficient is given as

$${S}_{f} ( m , n ) = sum ( S ⊙ {ϕ}_{m , n}^{( b )} )$$

where ⊙ is element-wise multiplication sum(.) denotes the sum of all elements of a matrix, Superscript b denotes the choice of basis,

$${ϕ}_{m , n}^{( b )}$$

is the (m,n)th basis function.

Sometimes, In one embodiment the 2D—basis matrix can be written as product of two 1D-basis as

$${∅}_{m , n}^{( b )} = {∅}_{m}^{( b , {N}_{3} )} {∅}_{n}^{( b , {N}_{4} ) T}$$

where

$${∅}_{m , n}^{( b )} is {N}_{3} \times {N}_{4} , {∅}_{m}^{( b , N )} is N \times 1.$$

Some examples of

$${∅}_{m}^{( b , N )}$$

are given.

If basis b is DFT then

$${∅}_{m}^{( b . N )} = mth$$

column of the DFT matrix of size N×N.

If basis is Slepain,

$${∅}_{m}^{( b , N )}$$

is the moth Slepian sequence. This will be characterized by a parameter, half-bandwidth product.

If basis is polynomial

$${∅}_{m}^{( b , N )}$$

is the mth column of matrix

$$A = [ \begin{matrix}1 & 1 & ⋯ & 1 \\ ⋮ & ⋮ & ⋯ & ⋮ \\ 1 & {N}^{2} & ⋯ & {N}^{N - 1}\end{matrix} ]$$

2D basis coefficients:

In another embodiment, some further examples of

$${ϕ}_{m , n}^{( b )}$$

are given for

$$2 D - DFT {,}_{{ϕ}_{m , n}^{( b )} ( p , q ) = {e}^{- j 2 π ( \frac{mp}{{N}_{3}} + \frac{nq}{{N}_{4}} )}} .$$

p is an integer between 0 and N₃−1. q is an integer between 0 and N₄−1. For oversampled DFT, with oversampling factors O₁ and O₂,

$${ϕ}_{m , n}^{( b )} ( p , q ) = {e}^{- j 2 π ( \frac{mp}{{O}_{1} {N}_{3}} + \frac{nq}{{O}_{2} {N}_{4}} )} .$$

p is an integer between 0 and N₃−1. q is an integer between 0 and N₄−1.

FIG. 19 illustrates a block diagram of a terminal (or a user equipment (UE)), according to embodiments disclosed herein. FIG. 19 corresponds to the example of the UE of FIG. 5.

As shown in FIG. 19, the UE according to an embodiment may include a transceiver 1910, a memory 1920, and a processor 1930. The transceiver 1910, the memory 1920, and the processor 1930 of the UE may operate according to a communication method of the UE described above. However, the components of the UE are not limited thereto. For example, the UE may include more or fewer components than those described above. In addition, the processor 1930, the transceiver 1910, and the memory 1920 may be implemented as a single chip. Also, the processor 1930 may include at least one processor.

The transceiver 1910 collectively refers to a UE receiver and a UE transmitter, and may transmit/receive a signal to/from a base station or a network entity. The signal transmitted or received to or from the base station or a network entity may include control information and data. The transceiver 1910 may include a RF transmitter for up-converting and amplifying a frequency of a transmitted signal, and a RF receiver for amplifying low-noise and down-converting a frequency of a received signal. However, this is only an example of the transceiver 1910 and components of the transceiver 1910 are not limited to the RF transmitter and the RF receiver.

Also, the transceiver 1910 may receive and output, to the processor 1930, a signal through a wireless channel, and transmit a signal output from the processor 1930 through the wireless channel.

The memory 1920 may store a program and data required for operations of the UE. Also, the memory 1920 may store control information or data included in a signal obtained by the UE. The memory 1920 may be a storage medium, such as read-only memory (ROM), random access memory (RAM), a hard disk, a CD-ROM, and a DVD, or a combination of storage media.

The processor 1930 may control a series of processes such that the UE operates as described above. For example, the transceiver 1910 may receive a data signal including a control signal transmitted by the base station or the network entity, and the processor 1930 may determine a result of receiving the control signal and the data signal transmitted by the base station or the network entity.

FIG. 20 illustrates a block diagram of network apparatus (or a base station), according to embodiments disclosed herein. FIG. 20 corresponds to the example of the network apparatus of FIG. 6.

As shown in FIG. 20, the base station according to an embodiment may include a transceiver 2010, a memory 2020, and a processor 2030. The transceiver 2010, the memory 2020, and the processor 2030 of the base station may operate according to a communication method of the base station described above. However, the components of the base station are not limited thereto. For example, the base station may include more or fewer components than those described above. In addition, the processor 2030, the transceiver 2010, and the memory 2020 may be implemented as a single chip. Also, the processor 2030 may include at least one processor.

The transceiver 2010 collectively refers to a base station receiver and a base station transmitter, and may transmit/receive a signal to/from a terminal or a network entity. The signal transmitted or received to or from the terminal or a network entity may include control information and data. The transceiver 2010 may include a RF transmitter for up-converting and amplifying a frequency of a transmitted signal, and a RF receiver for amplifying low-noise and down-converting a frequency of a received signal. However, this is only an example of the transceiver 2010 and components of the transceiver 2010 are not limited to the RF transmitter and the RF receiver.

Also, the transceiver 2010 may receive and output, to the processor 2030, a signal through a wireless channel, and transmit a signal output from the processor 2030 through the wireless channel.

The memory 2020 may store a program and data required for operations of the base station. Also, the memory 2020 may store control information or data included in a signal obtained by the base station. The memory 2020 may be a storage medium, such as read-only memory (ROM), random access memory (RAM), a hard disk, a CD-ROM, and a DVD, or a combination of storage media.

The processor 2030 may control a series of processes such that the base station operates as described above. For example, the transceiver 2010 may receive a data signal including a control signal transmitted by the terminal, and the processor 2030 may determine a result of receiving the control signal and the data signal transmitted by the terminal.

In the afore-described embodiments of the present disclosure, elements included in the present disclosure are expressed in a singular or plural form according to the embodiments. However, the singular or plural form is appropriately selected for convenience of explanation and the present disclosure is not limited thereto. As such, an element expressed in a plural form may also be configured as a single element, and an element expressed in a singular form may also be configured as plural elements.

The various actions, acts, blocks, steps, or the like in the method is performed in the order presented, in a different order or simultaneously. Further, in some embodiments, some of the actions, acts, blocks, steps, or the like are omitted, added, modified, skipped, or the like without departing from the scope of the proposed method.

The foregoing description of the specific embodiments will so fully reveal the general nature of the embodiments herein that others can, by applying current knowledge, readily modify and or adapt for various applications such specific embodiments without departing from the generic concept, and, therefore, such adaptations and modifications are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1. A method performed by a user equipment (UE) in a wireless network system, the method comprising:
receiving, from a base station (BS), at least one channel state information-reference signal (CSI-RS) configuration and at least one corresponding CSI-RS, wherein the at least one CSI-RS configuration and the at least one corresponding CSI-RS corresponds to at least one transmission reception point (TRP) out of multiple TRPs of the BS;
selecting a set of basis vectors and corresponding basis coefficients, for representing an entity corresponding to each CSI-RS in a spatial domain (SD), a frequency domain (FD) and a doppler or time domain (DD) for each TRP of the multiple TRPs based on the at least one CSI-RS configuration, wherein the entity is a channel or eigen vector of a channel covariance matrix;
identifying at least one transmission parameter feedback corresponding to at least one of the multiple TRPs based on the selected set of basis vectors and basis coefficients that represents the entity in the SD, the FD and the DD;
transmitting, to the BS, a CSI report of the feedback, the CSI report including the at least one transmission parameter corresponding to at least one of the multiple TRPs; and
receiving, from the BS, downlink transmission using the at least one TRP based on the transmission parameter feedback.

2. The method of claim 1, wherein the entity is in spatial domain corresponding to antennas for a given subband and time, called as spatial entity, wherein the spatial entity is processed across subbands for a given time, wherein a subband is a set of contiguous one or more subcarriers in frequency domain, wherein the spatial entity for a particular subband and a particular time is called as spatial-frequency entity, and wherein the spatial-frequency entity is processed across time and is called as spatial-frequency-time entity.

3. The method of claim 1, wherein the method further comprises:
receiving, from the BS, a pre-coded data using the at least one transmission parameter; and
decoding the pre-coded data received from the BS.

4. The method of claim 1, wherein the at least one transmission parameter feedback comprises at least one of the basis coefficients in at least one dimension of the SD, the FD and the DD, and indices to determine the basis vectors in at least one dimension of SD, FD, DD corresponding to a precoding matrix for at least one TRP of the multiple TRPs.

5. A method performed by a base station (BS) in a wireless communication system, the method comprising:
transmitting, to a user equipment (UE), at least one channel state information-reference signal (CSI-RS) configuration and at least one corresponding CSI-RS, wherein the at least one CSI-RS configuration and the at least one corresponding CSI-RS corresponds to at least one transmission reception point (TRP) out of multiple TRPs of the BS;
receiving, from the UE, a CSI report including transmission parameter feedback corresponding to the at least one TRP of multiple TRP of the BS;
precoding in at least one TRP data based on the transmission parameter feedback; and
transmitting, to the UE, the pre-coded data in a downlink transmission using the at least one TRP of the multiple TRPs based on the transmission parameter feedback.

6. The method of claim 5, wherein precoding data based on the transmission parameter feedback further comprises:
receiving, from the UE, spatial entity basis coefficients and the spatial entity basis vectors for at least one subband and at least one time instant for the at least one TRP of the multiple TRPs based on the transmission parameter feedback, wherein the spatial entity basis vectors and the spatial entity basis coefficients are represents an entity corresponding to the at least one CSI-RS in at least one of a spatial domain (SD), a frequency domain (FD) and a doppler or time domain (DD) for the at least one TRP based on the at least one CSI-RS configuration;
receiving, from the UE, at least one of time-frequency spatial basis coefficients, time-frequency spatial basis vectors, spatial frequency compressed basis vectors, spatial frequency time compressed basis vectors, spatial frequency time compressed basis coefficients for at least one TRP; and
precoding data based on the spatial entity basis coefficients and the spatial entity basis vectors, time-frequency spatial basis coefficients, time-frequency spatial basis vectors, spatial frequency compressed basis vectors, spatial frequency time compressed basis vectors, spatial frequency time compressed basis coefficients.

7. The method of claim 5, wherein the at least one transmission parameter feedback comprises at least one of the basis coefficients in at least one dimension of the SD, the FD and the DD, and indices to determine basis vectors in at least one dimension of the SD, the FD, the DD corresponding to a precoding matrix for at least one TRP of the multiple TRPs.

8. The method of claim 5, wherein the entity is a channel or eigen vector of a channel covariance matrix, and wherein the entity is in spatial domain corresponding to antennas for a given subband and time, called as spatial entity, wherein the spatial entity is processed across subbands for a given time, wherein a subband is a set of contiguous one or more subcarriers in frequency domain, wherein the spatial entity for a particular subband and a particular time is called as spatial-frequency entity, and wherein the spatial-frequency entity is processed across time and is called as spatial-frequency-time entity.

9. A user equipment (UE) in a wireless network system, the UE comprising:
a memory;
a processor;
a communicator; and
a coherent joint transmission controller, coupled to the memory and the processor), wherein the coherent joint transmission controller is configured to:
receive, from a base station (BS), at least one channel state information-reference signal (CSI-RS) configuration and at least one corresponding CSI-RS, wherein the at least one CSI-RS configuration and one at least one corresponding CSI-RS corresponds to a transmission reception point (TRP) out of multiple TRPs of the BS;
select a set of basis vectors and corresponding basis coefficients, for representing an entity corresponding to each CSI-RS in a spatial domain (SD), a frequency domain (FD) and a doppler or time domain (DD) for each TRP of the multiple TRPs based on the at least one CSI-RS configuration, wherein the entity is a channel or eigen vector of a channel covariance matrix;
identify at least one transmission parameter feedback corresponding to at least one of the multiple TRPs based on the selected set of basis vectors and basis coefficients that represents the entity in the SD, the FD and the DD;
transmit, to the BS, a CSI report of the feedback, wherein the CSI report comprises the at least one transmission parameter corresponding to at least one of the multiple TRPs; and
receive, from the BS, downlink transmission using the at least one TRP based on the transmission parameter feedback.

10. The UE of claim 9, wherein the entity is in spatial domain corresponding to antennas for a given subband and time, called as spatial entity, wherein the spatial entity is processed across subbands for a given time, wherein a subband is a set of contiguous one or more subcarriers in frequency domain, wherein the spatial entity for a particular subband and a particular time is called as spatial-frequency entity, and wherein the spatial-frequency entity is processed across time and is called as spatial-frequency-time entity.

11. The UE of claim 9, wherein the coherent joint transmission controller is further configured to:
receive, from the BS, a pre-coded data using the at least one transmission parameter; and
decode the pre-coded data received from the BS.

12. The UE of claim 9, wherein the at least one transmission parameter feedback comprises at least one of the basis coefficients in at least one dimension of the SD, the FD and the DD, and indices to determine the basis vectors in at least one dimension of SD, FD, DD corresponding to a precoding matrix for at least one TRP of the multiple TRPs.

13. A base station (BS) in a wireless communication system, the BS comprising:
a memory;
a processor;
a communicator; and
a coherent joint transmission controller, coupled to the memory and the processor, wherein the coherent joint transmission controller is configured to:
transmit, to a user equipment (UE), at least one channel state information-reference signal (CSI-RS) configuration and at least one corresponding CSI-RS, wherein the at least one CSI-RS configuration and the at least one corresponding CSI-RS corresponds to at least one transmission reception point (TRP) out of multiple TRPs of the BS;
receive, from the UE, a CSI report including transmission parameter feedback corresponding to the at least one TRP of multiple TRP of the BS;
precode in at least one TRP data based on the transmission parameter feedback; and
transmit, to the UE, the pre-coded data in a downlink transmission using the at least one TRP of the multiple TRPs based on the transmission parameter feedback.

14. The BS of claim 13, wherein the coherent joint transmission controller is further configured to:
receive, from the UE, spatial entity basis coefficients and the spatial entity basis vectors for at least one subband and at least one time instant for the at least one TRP of the multiple TRPs based on the transmission parameter feedback, wherein the spatial entity basis vectors and the spatial entity basis coefficients are represents an entity corresponding to the at least one CSI-RS in at least one of a spatial domain (SD), a frequency domain (FD) and a doppler or time domain (DD) for the at least one TRP based on the at least one CSI-RS configuration;
receive, from the UE, at least one of time-frequency spatial basis coefficients, time-frequency spatial basis vectors, spatial frequency compressed basis vectors, spatial frequency time compressed basis vectors, spatial frequency time compressed basis coefficients for at least one TRP; and
precode data based on the spatial entity basis coefficients and the spatial entity basis vectors, time-frequency spatial basis coefficients, time-frequency spatial basis vectors, spatial frequency compressed basis vectors, spatial frequency time compressed basis vectors, spatial frequency time compressed basis coefficients.

15. The BS of claim 13, wherein the at least one transmission parameter feedback comprises at least one of the basis coefficients in at least one dimension of the SD, the FD and the DD, and indices to determine basis vectors in at least one dimension of the SD, the FD, the DD corresponding to a precoding matrix for at least one TRP of the multiple TRPs.
